(19) United States
(12) Patent Application Publication
(10) Pub. No.: US 2022/0161276 A1
(43) Pub. Date: May 26, 2022

(54) MIXTURE OF FATTY ACIDS AND ALKYLETHER PHOSPHATES AS A COLLECTOR FOR PHOSPHATE ORE FLOTATION

(71) Applicant: BASF SE, Ludwigshafen am Rein (DE)

(72) Inventors: Rostislav Kamkin, Moscow (RU); Alexej Michailovski, Ludwigshafen (DE)

(21) Appl. No.: 17/425,869

(22) PCT Filed: Jan. 29, 2020
(86) PCT No.: PCT/EP2020/052116

§ 371 Date: Jul. 26, 2021

(30) Foreign Application Priority Data
Feb. 1, 2019 (RU) PCT/RU2019/000063

(51) Int. Cl. B03D 1/014; B03D 1/008; B03D 1/004; B03D 1/02

(52) U.S. Cl. CPC B03D 1/014; B03D 1/008; B03D 2203/06; B03D 1/021; B03D 2201/02; B03D 1/0043

(57) ABSTRACT

The present invention relates to a collector composition for the beneficiation of phosphates from phosphate-containing mineral, their use in flotation processes and to a method for the beneficiation of phosphates using said collector composition.

### FIELD OF THE INVENTION

The present invention relates to a collector composition for the beneficiation of phosphates from phosphate-containing mineral, their use in flotation processes and a method for the beneficiation of phosphates-containing mineral using said collector composition.

### BACKGROUND OF THE INVENTION

The global depletion of easily accessible high-grade phosphate deposits leads to a rising demand of beneficiation technologies in phosphate ore processing, in order to make low-grade phosphate rock accessible as phosphate source. In principle, the phosphate-containing ores are processed to achieve an apatite concentrate, which is further processed to phosphoric acid and then into fertilizers. Typically, flotation processes, either direct and/or reverse flotation processes, are applied for the beneficiation of phosphate-containing ores and often several flotation stages are required. The froth flotation as separation technology in principle makes use of differences in hydrophobicity between the valuable desired material and the waste gangue impurities. For phosphate ores, the type of phosphate deposit affects the flotation performance. For sedimentary deposits of phosphate ores, the desired phosphate concentration can be achieved by flotation of silicate impurities from the finely ground phosphate-containing ores (reverse flotation), when the gangue impurities essentially consist of siliceous materials. For sedimentary phosphates with high carbonates, however, beneficiation of phosphate ores by separation of carbonate from phosphate presents specific difficulties, because it requires a reagent selective between two chemically similar surfaces (apatite vs. calcite) (H. Sis et al., Minerals Engineering, 16 (2003) 577-585).

Both direct apatite flotation (e.g. from igneous ores) and reverse flotation (flotation of the carbonate and/or silicate impurities contained in the phosphoric rock) typically use fatty acid-based collector systems as reagents to increase the differences in hydrophobicity between the desired and undesired material. The main primary collectors are based on partly unsaturated fatty acids (C₁₂-C₁₈). Since fatty acids are sparingly soluble in water, secondary collectors are used, typically anionic or nonionic surfactants, to improve selectivity and recovery.

Surfactants are amphiphilic interface-active compounds which comprise a hydrophobic molecular moiety and also a hydrophilic molecular moiety and, in addition, can have charged and uncharged groups. Surfactants are oriented and absorbed at interfaces, thereby reduce the interfacial tension so that these can form, in solution, associated colloids above the critical micelle-formation concentration, meaning that substances which are per se water-insoluble are solubilized. On account of these properties, surfactants are used, for example, for wetting such as fibers or hard surfaces. Typical fields of application are detergents and cleaners for textiles and leather, as formulation of paints and coatings and also for example in the flotation process of non-sulfidic ores.

The effect of a secondary collector on flotation performance is critical due to the low solubility and limited self-emulsification ability of fatty acids at low pH, which in turn is required to achieve selectivity between carbonates and phosphates (e.g. calcite and apatite). A common class of high-performance flotation additives for the phosphate beneficiation are alkyl phenol ethoxylates (APEOs), powerful emulsifying additives with a hazardous environmental profile whose application is restricted or banned in many jurisdictions. Other suitable secondary collectors are sulfonate compounds. A typical P₂O₅ grade of up to 30 wt. % can be achieved starting with a typical sedimentary ore containing approx. 15 to 20 wt. % P₂O₅ by using these collectors. However, particularly in the fertilizer industry, a P₂O₅ content larger than 30% is often required. WO 2018/197476 discloses nonionic based surfactant on alkoxylated alcohols as a collector with greater recovery of the P₂O₅ especially in reverse floatation. However, the recovery of the P₂O₅ especially in direct floatation was somewhat limited.

WO 2010/070088 describes mixtures of surfactants comprising branched short-chain and branched long-chain components, which are alkoxylation products of alkanols. The short-chain alkanols contain 8 to 12 carbon atoms, C₂₋₁₀ alkoxy groups and a degree of branching of at least 1. The long-chain alkanols contain 15 to 19 carbon atoms, C₂₋₁₀ alkoxy groups and a degree of branching of at least 2.5.

U.S. Pat. No. 8,657,118 discloses a collector for the separation of phosphate by flotation of carbonates contained in non-sulfurous minerals, particularly phosphoric rock, preferably apatite. The collector comprises phosphoric ester.

WO 2016/041916 discloses the use of branched fatty alcohol-based compounds selected from the group of fatty alcohols with 12-16 carbon atoms having a degree of branching of 1-3, and their alkoxylates with a degree of ethoxylation of up to 3, as secondary collector for the froth flotation of non-sulfidic ores in combination with a primary collector selected from the group of amphoteric and anionic surface-active compounds. The use of the same for reverse flotation is not disclosed.

US 2003143134 A1 discloses the use of alkyl phosphate along with fatty acid for the floatation of the phosphate ores. However, the concentration of the P2O5 is less than 30 wt. %.

WO 1984/01114 A1 discloses the use of nonylphenyl polyethoxy phosphate and oleyl polyethoxy phosphate along with oleic acid as collector composition for clay flotation.

Thus, it is an object of the presently claimed invention to provide a collector composition that can be used in a low amount to produce a high-grade phosphate mineral concentrate and which can be isolated in high yield, in particular a high-grade apatite concentrate.

### SUMMARY OF THE INVENTION

Surprisingly, it was found that a high-grade phosphate mineral concentrate can be obtained in a high yield by using the collector composition according to the presently claimed invention in comparatively low amounts.

Thus, in a first aspect, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₈-C₂₂ fatty acids or derivatives thereof containing at least one C(═O)—OH group or salts thereof, and the at least one component B is a compound of formula (I),

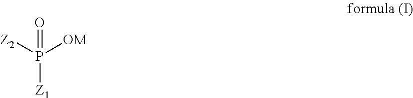

wherein
Z₁ is C₆-C₃₀-alkyl-O—(CH₂—CH₂—O)ₙ—(—CH(R³)—CH(R⁴)—O—)ₗ—(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl.

In a second aspect, the presently claimed invention is directed to a direct flotation process for the beneficiation of phosphates from phosphate-containing mineral comprising the steps of:
a) grinding phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting of the phosphate in the froth;
   wherein the collector composition is as defined as above.

In a third aspect, the presently claimed invention is directed to a reverse flotation process for the beneficiation of the phosphate-containing mineral by collection of impurities from phosphate-containing mineral in the froth, comprising the steps of:
a) grinding the phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting carbonate and/or other impurities in the froth, and
g) recovering the phosphates;
   wherein the collector composition is as defined as above.

In fourth aspect, the presently claimed invention is directed to a collector composition for the beneficiation of phosphates from phosphate-containing mineral comprising:
i. at least one component A,
ii. at least one component B, and
iii. at least one component C,
   wherein the at least one component A comprises saturated or unsaturated C₈-C₂₂ fatty acids or derivatives thereof containing at least one C(═O)—OH group or salts thereof, and the at least one component B is a compound of formula (I),

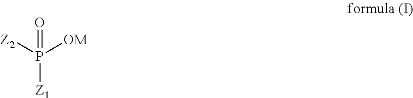

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl; and
   wherein the at least one component C is selected from the group consisting of formula (II), formula (III) and formula (IV), which is in each case different from the at least one component A and the at least one component B,

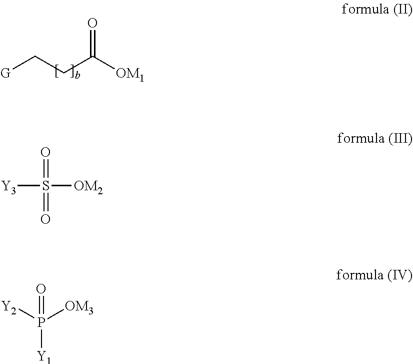

wherein
G is H or C(═O)-OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.

### DETAILED DESCRIPTION OF THE INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

As used herein, the term “flotation” relates to the separation of minerals based on differences in their hydrophobicity and their different ability to adhere or attach to air bubbles. The aim of flotation as mineral processing operation is to selectively separate certain materials. In particular, the flotation is used for the beneficiation of phosphates from phosphate-containing mineral. Flotation comprises froth flotation methods like for example direct flotation or reverse flotation. Direct flotation of phosphates refers to methods, wherein particular phosphates are collected in the froth and the impurities remain in the slurry. Reverse flotation or inverse flotation of phosphates relates to methods, wherein the impurities as undesired materials are collected in the froth and the phosphates remain in the slurry as cell product. In particular, reverse flotation of phosphates is similar to direct flotation of carbonates.

As used herein, the term “cell product” has the similar meaning as cell underflow or slurry and means the product remaining in the cell in particular in reverse flotation processes.

As used herein, the term “froth product” means the product obtained in the froth in particular in direct flotation processes.

As used herein, the term “concentrate” has the meaning of flotation product and refers to the material obtained as cell product (valuable material) in reverse flotation processes as well as to froth product as the material obtained in the froth (valuable material) in direct flotation processes.

As used herein, the term “tailings” or “flotation tailings” is understood economically and means the undesired products and impurities which are removed in direct or reverse flotation processes.

As used herein, the term “collector” relates to substances with the ability to adsorb to a mineral particle and to make the mineral particle hydrophobic in order to enable the mineral particle to attach to air bubbles during flotation. The collector may comprise, for example at least one or two or three different collectors. A collector composition may comprise collector components which are named for example primary, secondary, ternary collector and can influence the collector composition properties. A collector composition comprises in particular mixtures of fatty acids and surfactants. The collectors can in particular be surface-active, can have emulsification properties, can act as wetting agent, can be a solubility enhancer and/or a foam or froth regulator.

As used herein, the term “grade” relates to the content of the desired mineral or valuable or targeted material in the obtained concentrate after the enrichment via flotation. In particular, the grade is the concentration of P₂O₅ obtained by the phosphate flotation process. The grade in particular refers to the P₂O₅ concentration and describes the content of P₂O₅ in the concentrate (w/w), particularly in the froth product at direct phosphate flotation and the content of P₂O₅ in the cell product in reverse phosphate flotation.

As used herein, the term “recovery” refers to the percentage of valuable material recovered after the enrichment via flotation. The relationship of grade (concentration) vs. recovery (amount) is a measure for the selectivity of froth flotation. The selectivity increases with increasing values for grade and/or recovery. With the selectivity the effectiveness/performance of the froth flotation can be described.

In a first embodiment, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₈-C₂₂ fatty acids or derivatives thereof containing at least one C(═O)—OH group or salts thereof, and the at least one component B is a compound of formula (I).

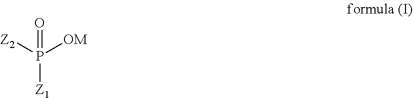

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl.

More preferably, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₈-C₂₂ fatty acids or derivatives thereof containing at least one C(═O)—OH group or salts thereof, and the at least one component B is a compound of formula (I),

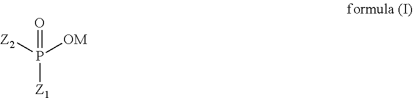

wherein
Z₁ is C₆-C₃₀-alkyl-O—(CH₂—CH₂—O)ₙ—(—CH(R³)—CH(R⁴)—O—)ₗ—(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤10; and
R³ and R⁴ are independently of each other selected from H and C₁-C₆-alkyl.

Even more preferably, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₈-C₂₂ fatty acids or salts thereof, and
   the at least one component B is a compound of formula (I),

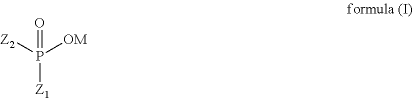

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium, or an alkali metal ion,
n is an integer in the range from ≥0 to ≤10,
l is an integer in the range from ≥0 to ≤5,
m is an integer in the range from ≥0 to ≤5,
the sum of l+m+n is an integer in the range from ≥1 to ≤10; and
R³ and R⁴ are independently of each other selected from H and C₁-C₃-alkyl.

Most preferably, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₈-C₂₂ fatty acids or salts thereof, and
   the at least one component B is a compound of formula (I),

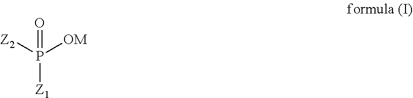

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium, or an alkali metal ion,
n is an integer in the range from ≥1 to ≤6,
l is an integer in the range from ≥0 to ≤5,
m is an integer in the range from ≥0 to ≤5,
the sum of l+m+n is an integer in the range from ≥1 to ≤10; and
R³ and R⁴ are independently of each other selected from H and methyl.

Even most preferably, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₁₂-C₂₂ fatty acids or salts thereof, and
   the at least one component B is a compound of formula (I),

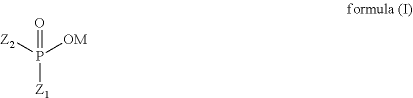

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥2 to ≤6,
l is an integer in the range from ≥0 to ≤3,
m is an integer in the range from ≥0 to ≤5,
the sum of l+m+n is an integer in the range from ≥2 to ≤9; and
R³ and R⁴ are independently of each other selected from H and methyl.

In particular preferably, the presently claimed invention is directed to use of a collector composition for the beneficiation of phosphates from phosphate-containing mineral, wherein the collector composition comprises:
i. at least one component A, and
ii. at least one component B,
   wherein the at least one component A comprises saturated or unsaturated C₁₅-C₁₈ fatty acids or salts thereof, and
   the at least one component B is a compound of formula (I),

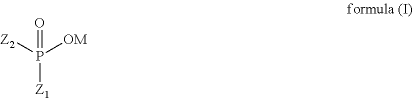

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥2 to ≤6,
l is an integer in the range from ≥0 to ≤3,
m is an integer in the range from ≥0 to ≤3,
the sum of l+m+n is an integer in the range from ≥2 to ≤9; and
R³ and R⁴ are independently of each other selected from H and methyl.

In another preferred embodiment, the presently claimed invention is directed to the use of a collector composition as defined above for the beneficiation of phosphates from phosphate-containing mineral, wherein the collector composition further comprises iii. at least one component C, which is different from the at least one component A and the at least one component B, wherein the at least one component C is of formula (II) or formula (III) or formula (IV),

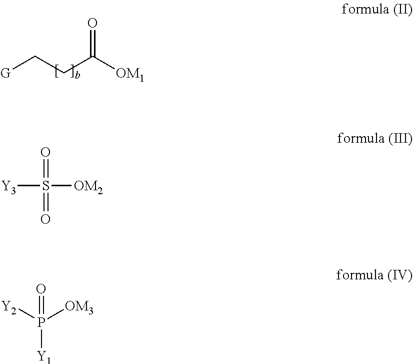

wherein
G is H or C(═O)-OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20,
R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, H, C₁-C₂₄ alkyl and C₂-C₂₄ alkenyl; and
R is selected from the group consisting of C₁-C₂₄ alkyl and C₂-C₂₄ alkenyl.

More preferably, the use of a collector composition for the beneficiation of phosphates from phosphate-containing mineral, wherein the collector composition comprises at least one component C of formula (II) or formula (III) or formula (IV), which is in each case different from the at least one component A and the at least one component B,

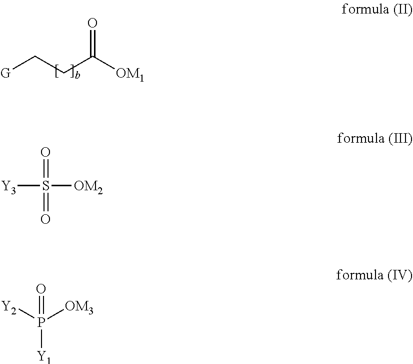

wherein
G is H or C(═O)-OM₄;
b is an integer in the range from ≥2 to ≤15;
Y₁ is selected from the group consisting of OM₆, C₆-C₂₀ alkyl, C₆-C₂₀ alkenyl, OR and C₆-C₂₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₆-C₂₀alkyl, C₆-C₂₀ alkenyl, OR and C₆-C₂₀-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20,
R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, H, C₁-C₂₄ alkyl and C₂-C₂₄ alkenyl; and
R is selected from the group consisting of C₁-C₂₄ alkyl and C₂-C₂₄ alkenyl.

Most preferably, the use of a collector composition for the beneficiation of phosphates from phosphate-containing mineral, wherein the collector composition comprises at least one component C of formula (II) or formula (III) or formula (IV), which is in each case different from the at least one component A and the at least one component B,

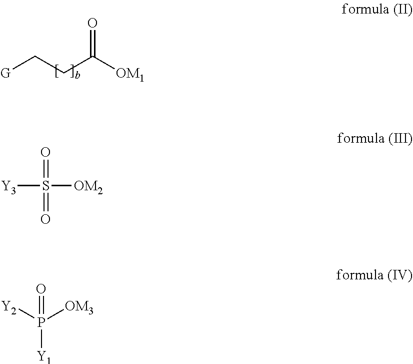

wherein
G is H or C(═O)-OM₄;
b is an integer in the range from ≥4 to ≤8;
Y₁, is selected from the group consisting of OM₆, C₁₀-C₁₈alkyl, C₁₀-C₂₀ alkenyl, OR and C₁₀-C₂₀-alkyl-O—(CH₂—CH₂—O)ₙ—(—CH(R³)—CH(R⁴)—O—)ₗ—(—CH₂—CH₂—O—)ₘ—,
Y₂ and Y₃ is selected from the group consisting of C₁₀-C₁₈alkyl, C₁₀-C₂₀ alkenyl, OR and C₁₀-C₂₀-alkyl-O—(CH₂—CH₂—O)ₙ—(—CH(R³)—CH(R⁴)—O—)ₗ(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤10,
R³ and R⁴ are independently of each other selected from H and C₁-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, H, C₁-C₂₄ alkyl and C₂-C₂₄ alkenyl; and
R is selected from the group consisting of C₁₂-C₁₈ alkyl and C₁₂-C₁₈ alkenyl.

In another preferred embodiment, the presently claimed invention is directed to the use of a collector composition as described above for direct flotation of phosphates by collecting the phosphate in the froth.

In another preferred embodiment, the presently claimed invention is directed to the use of a collector composition as described above for reverse flotation of the phosphates by collection of impurities from the phosphate-containing mineral in the froth.

In another preferred embodiment, the presently claimed invention is directed to the use of a collector composition for the beneficiation of phosphates from phosphate-containing mineral, wherein the degree of alkoxylation of the at least one component B is in the range of 0 to 10; more preferably the degree of alkoxylation of the at least one component B is in the range of 1 to 8; even more preferably the degree of alkoxylation of the at least one component B is in the range of 1 to 6; and most preferably the degree of alkoxylation of the at least one component B is in the range of 2 to 6.

In a preferred embodiment, the phosphate-containing minerals are selected from the group consisting of phosphorites, apatites, frondelite and stewarite. In another preferred embodiment the apatites are selected form the group consisting of hydroxyapatite, fluoroapatite, chloroapatite, carbonatoapatite and bromoapatite.

In another preferred embodiment, the the presently claimed invention is directed to the use of a collector composition for the beneficiation of phosphates from phosphate-containing mineral, wherein the amount of the at least one component A in the collector composition is in the range from ≥50 wt. % to ≤99.9 wt. %, based on the total weight of the collector composition; more preferably is in the range from ≥50 wt. % to ≤90 wt. %; even more preferably is in the range from ≥50 wt. % to ≤80 wt. %; most preferably is in the range from ≥60 wt. % to ≤80 wt. %; and in particular preferably is in the range from ≥60 wt. % to ≤75 wt. % based on the total weight of the collector composition.

In another preferred embodiment, the the presently claimed invention is directed to the use of a collector composition for the beneficiation of phosphates from phosphate-containing mineral, wherein the amount of the at least one component B in the collector composition is in the range from ≥0.1 wt. % to ≤50 wt. %, based on the total weight of the collector composition; more preferably is in the range from ≥5 wt. % to ≤50 wt. %; even more preferably is in the range from ≥10 wt. % to ≤40 wt. %; most preferably is in the range from ≥10 wt. % to ≤35 wt. %; and in particular preferably is in the range from ≥15 wt. % to ≤35 wt. %, based on the total weight of the collector composition.

In another preferred embodiment, the the presently claimed invention is directed to the use of a collector composition for the beneficiation of phosphates from phosphate-containing mineral, wherein the amount of the at least one component B in the collector composition is in the range from ≥10 wt. % to ≤30 wt. %, based on the total weight of the collector composition.

In another preferred embodiment, the the presently claimed invention is directed to the use of a collector composition for the beneficiation of phosphates from phosphate-containing mineral, the amount of the at least one component C in the collector composition is in the range from ≥0.1 wt. % to ≤20 wt. %, based on the total weight of the collector composition; preferably is in the range from ≥1 wt. % to ≤20 wt. %; more preferably is in the range from ≥5 wt. % to ≤20 wt. %; and in particular preferably is in the range from ≥8 wt. % to ≤20 wt. %; most preferably is in the range from ≥12 wt. % to ≤20 wt. %; based on the total weight of the collector composition.

### Component A

In a preferred embodiment, the at least one component A comprises saturated or unsaturated C₈-C₂₂ fatty acids or derivatives thereof containing at least one C(═O)—OH group or salts thereof. More preferably the derivatives are fatty acid peptides containing at least one C(═O)—OH group or salts thereof. In another preferred embodiment, the at least one saturated or unsaturated C₈-C₂₂ fatty acid derivatives is having a structure of saturated or unsaturated C₈-C₂₂—CO—NH—R with R being a residue of natural or artificial amino acids comprising glycine, sarcosine or taurine.

In a preferred embodiment, the saturated or unsaturated C₈-C₂₂ fatty acids are selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, isostearic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.

In a preferred embodiment, the component A is tall oil fatty acid.

### Component B

In another preferred embodiment, the at least one component B is a compound of formula (I),

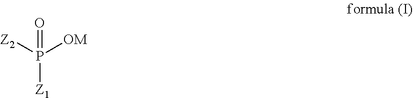

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl.

In a preferred embodiment, Z₁ is selected from the group consisting of C₆-C₃₀-alkyl-O—(CH₂—CH₂—O)₁, C₆-C₃₀-alkyl-O—(CH₂—CH₂—O)₂, C₆-C₃₀-alkyl-O—(CH₂—CH₂—O)₃, C₆-C₃₀-alkyl-O—(CH₂—CH₂—O)₄, C₆-C₃₀-alkyl-O—(CH₂—CH₂—O)₅, C₆-C₃₀-alkyl-O—(CH₂—CH₂—O)₆, C₆-C₃₀-alkyl-O—(CH₂—CH₂—O)₇, C₆-C₃₀-alkyl-O—(CH₂—CH₂—O)₈, C₆-C₃₀-alkyl-O—(CH₂—CH₂—O)₉, C₆-C₃₀-alkyl-O—(CH₂—CH₂—O)₁₀, C₆-C₃₀-alkyl-O—(CH₂—CH₂—O)₁₋₁₀—(—CH₂—CH(CH₃)—O—)₁, C₆-C₃₀-alkyl-O—(CH₂—CH₂—O)₁₋₁₀—(—CH₂—CH(CH₃)—O—)₂, C₆-C₃₀-alkyl-O—(CH₂—CH₂—O)₁₋₁₀—(—CH₂—CH(CH₃)—O—)₃, C₆-C₃₀-alkyl-O—(CH₂—CH₂—O)₁₋₁₀—(—CH₂—CH(CH₃)—O—)₄, C₆-C₃₀-alkyl-O—(CH₂—CH₂—O)₁₋₁₀—(—CH₂—CH(CH₃)—O—)₅, C₆-C₃₀-alkyl-O—(CH₂—CH₂—O)₁₋₁₀—(—CH₂CH(CH₃)—O—)₆, C₆-C₃₀-alkyl-O—(CH₂—CH₂—O)₁₋₁₀—(—CH₂—CH(CH₃)—O—)₇, C₆-C₃₀-alkyl-O—(CH₂—CH₂—O)₁₋₁₀—(—CH₂—CH(CH₃)—O—)₈, C₆-C₃₀-alkyl-O—(CH₂—CH₂—O)₁₋₁₀—(—CH₂—CH(CH₃)—O—)₉, C₆-C₃₀-alkyl-O—(CH₂—CH₂—O)₁₋₁₀—(—CH₂—CH(CH₃)—O—)₁₀, C₆-C₃₀-alkyl-O—(CH₂—CH₂—O)₁₋₁₀—(—CH(CH)—CH₂—O—)₆, C₆-C₃₀-alkyl-O—(CH₂—CH₂—O)₁₋₁₀—(—CH(CH₃)—CH₂—O—)₂, C₆-C₃₀-alkyl-O—(CH₂—CH₂—O)₁₋₁₀—(—CH(CH₃)—CH₂—O—)₃, C₆-C₃₀-alkyl-O—(CH₂—CH₂—O)₁₋₁₀—(—CH(CH₃)—CH₂—O—)₄, C₆-C₃₀-alkyl-O—(CH₂—CH₂—O)₁₋₁₀—(—CH(CH₃)—CH₂O—)₅, C₆-C₃₀-alkyl-O—(CH₂—CH₂—O)₁₋₁₀—(—CH(CH₃)—CH₂—O—)₆, C₆-C₃₀-alkyl-O—(CH₂—CH₂—O)₁₋₁₀—(—CH(CH₃)—CH₂O—)₇, C₆-C₃₀-alkyl-O—(CH₂—CH₂—O)₁₋₁₀—(—CH(CH)—CH₂—)₈, C₆-C₃₀-alkyl-O—(CH₂—CH₂—O)₁₋₁₀—(—CH(CH₃)—CH₂O—)₉, C₆-C₃₀-alkyl-O—(CH₂—CH₂—O)₁₋₁₀—(—CH(CH₃)—CH₂O—)₁₀, C₆-C₃₀-alkyl-O—(CH₂—CH₂—O)₁₋₁₀—(—CH₂—CH(CH₃)—O—)₁—(—CH₂—CH₂—O—)₁₋₁₀—, C₆-C₃₀-alkyl-O—(CH₂—CH₂—O)₁₋₁₀—(—CH₂—CH(CH₃)—O—)₂—(—CH₂—CH₂—O—)₁₋₁₀—, C₆-C₃₀-alkyl-O—(CH₂—CH₂—O)₁₋₁₀—(—CH₂—CH(CH₃)—O—)₃—(—CH₂—CH₂—O—)₁₋₁₀—, C₆-C₃₀-alkyl-O—(CH₂—CH₂—O)₁₋₁₀—(—CH₂CH(CH₃)—O—)₄—(—CH₂—CH₂—O—)₁₋₁₀—, C₆-C₃₀-alkyl-O—(CH₂—CH₂—O)₁₋₁₀—(—CH₂—CH(CH₃)—O—)₅—(—CH₂—CH₂—O—)₁₋₁₀—, C₆-C₃₀-alkyl-O—(CH₂—CH₂—O)₁₋₁₀—(—CH₂—CH(CH₃)—O—)₆—(—CH₂—CH₂—O—)₁₋₁₀—, C₆-C₃₀-alkyl-O—(CH₂—CH₂—O)₁₋₁₀—(—CH₂—CH(CH₃)—O—)₇—(—CH₂—CH₂—O—)₁₋₁₀—, C₆-C₃₀-alkyl-O—(CH₂—CH₂—O)₁₋₁₀—(—CH₂—CH(CH₃)—O—)₈—(—CH₂—CH₂—O—)₁₋₁₀—, C₆-C₃₀-alkyl-O—(CH₂—CH₂—O)₁₋₁₀—(—CH₂—CH(CH₃)—O—)₉—(—CH₂—CH₂—O—)₁₋₁₀—, C₆-C₃₀-alkyl-O—(CH₂—CH₂—O)₁₋₁₀—(—CH₂—CH(CH₃)—O—)₁₀—(—CH₂—CH₂—O—)₁₋₁₀—, C₆-C₃₀-alkyl-O—(CH₂—CH₂—O)₁₋₁₀—(—CH(CH₃)—CH₂—O—)₁—(—CH₂—CH₂—O—)₁₋₁₀—, C₆-C₃₀-alkyl-O—(CH₂—CH₂—O)₁₋₁₀—(—CH(CH₃)—CH₂—O—)₂—(—CH₂—CH₂—O—)₁₋₁₀—, C₆-C₃₀-alkyl-O—(CH₂—CH₂—O)₁₋₁₀—(—CH(CH₃)—CH₂O—)₃—(—CH₂—CH₂—O—)₁₋₁₀—, C₆-C₃₀-alkyl-O—(CH₂—CH₂—O)₁₋₁₀—(—CH(CH₃)—CH₂—O—)₄—(—CH₂—CH₂—O—)₁₋₁₀—, C₆-C₃₀-alkyl-O—(CH₂—CH₂—O)₁₋₁₀—(—CH(CH₃)—CH₂—O—)₅—(—CH₂—CH₂—O—)₁₋₁₀—, C₆-C₃₀-alkyl-O—(CH₂—CH₂—O)₁₋₁₀—(—CH(CH₃)—CH₂O—)₆—(—CH₂—CH₂—O—)₁₋₁₀—, C₆-C₃₀-alkyl-O—(CH₂—CH₂—O)₁₋₁₀—(—CH(CH)—CH₂—O—)₇—(—CH₂—CH₂—O—)₁₋₁₀—, C₆-C₃₀-alkyl-O—(CH₂—CH₂—O)₁₋₁₀—(—CH(CH₃)—CH₂O—)₈—(—CH₂—CH₂—O—)₁₋₁₀—, C₆-C₃₀-alkyl-O—(CH₂—CH₂—O)₁₋₁₀—(—CH(CH₃)—CH₂—O—)₉—(—CH₂—CH₂—O—)₁₋₁₀—, and C₆-C₃₀-alkyl-O—(CH₂—CH₂—O)₁₋₁₀—(—CH(CH₃)—CH₂—O—)₁₀—(—CH₂—CH₂—O—)₁₋₁₀—.

More preferably Z₁ is selected from the group consisting of C₁₂-C₁₈-alkyl-O—(CH₂—CH₂—O)₁, C₁₂-C₁₈-alkyl-O—(CH₂—CH₂—O)₂, C₁₂-C₁₈-alkyl-O—(CH₂—CH₂—O)₃, C₁₂-C₁₈-alkyl-O—(CH₂—CH₂—O)₄, C₁₂-C₁₈-alkyl-O—(CH₂—CH₂—O)₅, C₁₂-C₁₈-alkyl-O—(CH₂—CH₂—O)₁₋₇—(—CH₂—CH(CH₃)—O—)₁, C₁₂-C₁₈-alkyl-O—(CH₂—CH₂—O)₁₋₇—(—CH₂CH(CH₃)—O—)₂, C₁₂-C₁₈-alkyl-O—(CH₂—CH₂—O)₁₋₇—(—CH₂—CH(CH₃)—O—)₃, C₁₂-C₁₈-alkyl-O—(CH₂—CH₂—O)₁₋₇—(—CH₂CH(CH₃)—O—)₄, C₁₂-C₁₈-alkyl-O—(CH₂—CH₂—O)₁₋₇—(—CH₂—CH(CH₃)—O—)₅, C₁₂-C₁₈-alkyl-O—(CH₂—CH₂—O)₁₋₇—(—CH(CH₃)—CH₂—O—)₁, C₁₂-C₁₈-alkyl-O—(CH₂—CH₂—O)₁₋₇—(—CH(CH₃)—CH₂—O—)₂, C₁₂-C₁₈-alkyl-O—(CH₂—CH₂—O)₁₋₇—(—CH(CH₃)—CH₂O—)₃, C₁₂-C₁₈-alkyl-O—(CH₂—CH₂—O)₁₋₇—(—CH(CH₃)—CH₂—O—)₄, C₁₂-C₁₈-alkyl-O—(CH₂—CH₂—O)₁₋₇—(—CH(CH₃)—CH₂—O—)₅, C₁₂-C₁₈-alkyl-O—(CH₂—CH₂—O)₁₋₇—(—CH₂—CH(CH₃)—O—)₁—(—CH₂—CH₂—O—)₁₋₇—, C₁₂-C₁₈-alkyl-O—(CH₂—CH₂—O)₁₋₇—(—CH₂—CH(CH₃)—O—)₂—(—CH₂—CH₂—O—)₁₋₇—, C₁₂-C₁₈-alkyl-O—(CH₂—CH₂—O)₁₋₇—(—CH₂—CH(CH₃)—O—)₃—(—CH₂—CH₂—O—)₁₋₇—, C₁₂-C₁₈-alkyl-O—(CH₂—CH₂—O)₁₋₇—(—CH₂—CH(CH₃)—O—)₄—(—CH₂—CH₂—O—)₁₋₇—, C₁₂-C₁₈-alkyl-O—(CH₂—CH₂—O)₁₋₇—(—CH₂—CH(CH₃)—O—)₅—(—CH₂—CH₂—O—)₁₋₇—, C₁₂-C₁₈-alkyl-O—(CH₂—CH₂—O)₁₋₇—(—CH(CH₃)—CH₂—O—)₁—(—CH₂—CH₂—O—)₁₋₇—, C₁₂-C₁₈-alkyl-O—(CH₂—CH₂—O)₁₋₇—(—CH(CH₃)—CH₂—O—)₂—(—CH₂—CH₂—O—)₁₋₇—, C₁₂-C₁₈-alkyl-O—(CH₂—CH₂—O)₁₋₇—(—CH(CH₃)—CH₂—O—)₃—(—CH₂—CH₂—O—)₁₋₇—, C₁₂-C₁₈-alkyl-O—(CH₂—CH₂—O)₁₋₇—(—CH(CH₃)—CH₂—O—)₄—(—CH₂—CH₂—O—)₁₋₇— and C₁₂-C₁₈-alkyl-O—(CH₂—CH₂—O)₁₋₇—(—CH(CH₃)—CH₂—O—)₅—(—CH₂—CH₂—O—)₁₋₇—.

In a preferred embodiment, the Z₂ is selected from the group consisting of, but not limited to, OH, ONa, OK, ONH₄, C₆-C₃₀-alkyl-O—(CH₂—CH₂—O)₁, C₆-C₃₀-alkyl-O—(CH₂—CH₂—O)₂, C₆-C₃₀-alkyl-O—(CH₂—CH₂—O)₃, C₆-C₃₀-alkyl-O—(CH₂—CH₂—O)₄, C₆-C₃₀-alkyl-O—(CH₂—CH₂—O)₅, C₆-C₃₀-alkyl-O—(CH₂—CH₂—O)₆, C₆-C₃₀-alkyl-O—(CH₂—CH₂—O)₇, C₆-C₃₀-alkyl-O—(CH₂—CH₂—O)₈, C₆-C₃₀-alkyl-O—(CH₂—CH₂—O)₉, C₆-C₃₀-alkyl-O—(CH₂—CH₂—O)₁₀, C₆-C₃₀-alkyl-O—(CH₂—CH₂—O)₁₋₁₀—(—CH₂—CH(CH₃)—O—)₁, C₆-C₃₀-alkyl-O—(CH₂—CH₂—O)₁₋₁₀—(—CH₂—CH(CH)—O—)₂, C₆-C₃₀-alkyl-O—(CH₂—CH₂—O)₁₋₁₀—(—CH₂—CH(CH₃)—O—)₃, C₆-C₃-alkyl-O—(CH₂—CH₂—O)₁₋₁₀—(—CH₂—CH(CH₃)—O—)₄, C₆-C₃₀-alkyl-O—(CH₂—CH₂—O)₁₋₁₀—(—CH₂—CH(CH₃)—O—)₅, C₆-C₃₀-alkyl-O—(CH₂—CH₂—O)₁₋₁₀—(—CH₂—CH(CH₃)—O—)₆, C₆-C₃₀-alkyl-O—(CH₂—CH₂—O)₁₋₁₀—(—CH₂—CH(CH)—O—)₇, C₆-C₃₀-alkyl-O—(CH₂—CH₂—O)₁₋₁₀—(—CH₂—CH(CH₃)—O—)₈, C₆-C₃₀-alkyl-O—(CH₂—CH₂—O)₁₋₁₀—(—CH₂—CH(CH)—O—)₉, C₆-C₃₀-alkyl-O—(CH₂—CH₂—O)₁₋₁₀—(—CH₂—CH(CH₃)—O—)₁₀, C₆-C₃₀-alkyl-O—(CH₂—CH₂—O)₁₋₁₀—(—CH(CH₃)—CH₂O—)₁, C₆-C₃₀-alkyl-O—(CH₂—CH₂—O)₁₋₁₀—(—CH(CH₃)—CH₂—O—)₂, C₆-C₃₀-alkyl-O—(CH₂—CH₂—O)₁₋₁₀—(—CH(CH₃)—CH₂O—)₃, C₆-C₃₀-alkyl-O—(CH₂—CH₂—O)₁₋₁₀—(—CH(CH₃)—CH₂—O—)₄, C₆-C₃₀-alkyl-O—(CH₂—CH₂—O)₁₋₁₀—(—CH(CH₃)—CH₂O—)₅, C₆-C₃₀-alkyl-O—(CH₂—CH₂—O)₁₋₁₀—(—CH(CH₃)—CH₂O—)₆, C₆-C₃₀-alkyl-O—(CH₂—CH₂—O)₁₋₁₀—(—CH(CH₃)—CH₂—O—)₂, C₆-C₃₀-alkyl-O—(CH₂—CH₂—O)₁₋₁₀—(—CH(CH₃)—CH₂O—)₈, C₆-C₃₀-alkyl-O—(CH₂—CH₂—O)₁₋₁₀—(—CH(CH₃)—CH₂—O—)₉, C₆-C₃₀-alkyl-O—(CH₂—CH₂—O)₁₋₁₀—(—CH(CH₃)—CH₂O—)₁₀, C₆-C₃₀-alkyl-O—(CH₂—CH₂—O)₁₋₁₀—(—CH₂—CH(CH₃)₋₆—O—)₁—(—CH₂—CH₂—O—)₁₋₁₀—, C₆-C₃₀-alkyl-O—(CH₂—CH₂—O)₁₋₁₀—(—CH₂—CH(CH₃)—O—)₂—(—CH₂—CH₂—O—)₁₋₁₀—, C₆-C₃₀-alkyl-O—(CH₂—CH₂—O)₁₋₁₀—(—CH₂—CH(CH₃)—O—)₃—(—CH₂—CH₂—O—)₁₋₁₀—, C₆-C₃₀-alkyl-O—(CH₂—CH(CH₃)—O—)₁₋₁₀—(—CH₂—CH(CH₃)—O—)₄—(—CH₂—CH₂—O—)₁₋₁₀—, C₆-C₃₀-alkyl-O—(CH₂—CH₂—O)₁₋₁₀—(—CH₂—CH(CH₃)—O—)₅—(—CH₂—CH₂—O—)₁₋₁₀—, C₆-C₃₀-alkyl-O—(CH₂—CH₂—O)₁₋₁₀—(—CH₂CH(CH₃)—O—)₆—(—CH₂—CH₂—O—)₁₋₁₀—, C₆-C₃₀-alkyl-O—(CH₂—CH₂—O)₁₋₁₀—(—CH₂—CH(CH₃)—O—)₇—(—CH₂—CH₂—O—)₁₋₁₀, C₆-C₃₀-alkyl-O—(CH₂—CH₂—O)₁₋₁₀—(—CH₂—CH(CH₃)—O—)₈—(—CH₂—CH₂—O—)₁₋₁₀—, C₆-C₃₀-alkyl-O—(CH₂—CH₂—O)₁₋₁₀—(—CH₂—CH(CH₃)—O—)₉—(—CH₂—CH₂—O—)₁₋₁₀—, C₆-C₃₀-alkyl-O—(CH₂—CH₂—O)₁₋₁₀—(—CH₂—CH(CH₃)—O—)₁₀—(—CH₂—CH₂—O—)₁₋₁₀—, C₆-C₃₀alkyl-O—(CH₂—CH₂—O)₁₋₁₀—(—CH(CH₃)—CH₂—O—)₁—(—CH₂—CH₂O—)₁₋₁₀—, C₆-C₃₀-alkyl-O—(—CH₂—O)₁₋₁₀—(—CH(CH₃)—CH₂—O—)₂—(—CH₂—CH₂—O—)₁₋₁₀—, C₆-C₃₀-alkyl-O—(CH₂—CH₂—O)₁₋₁₀—(—CH(CH₃)—CH₂—O—)₃—(—CH₂—CH₂—O—)₁₋₁₀—, C₆-C₃₀-alkyl-O—(CH₂—CH₂—O)₁₋₁₀—(—CH(CH₃)—CH₂—O—)₄—(—CH₂—CH₂—O—)₁₋₁₀, C₆-C₃₀-alkyl-O—(CH₂—CH₂—O)₁₋₁₀—(—CH(CH₃)—CH₂—O—)₅—(—CH₂—CH₂—O—)₁₋₁₀—, C₆-C₃₀-alkyl-O—(CH₂—CH₂—O)₁₋₁₀—(—CH(CH₃)—CH₂—O—)₆—(—CH₂—CH₂—O—)₁₋₁₀—, C₆-C₃₀-alkyl-O—(CH₂—CH₂—O)₁₋₁₀—(—CH(CH₃)—CH₂—O—)₇—(—CH₂—CH₂—O—)₁₋₁₀—, C₆-C₃₀-alkyl-O—(CH₂—CH₂—O)₁₋₁₀—(—CHO(CH₃)—CH₂—O—)₈—(—CH₂—CH₂—O—)₁₋₁₀—, C₆-C₃₀-alkyl-O—(CH₂—CH₂—O)₁₋₁₀—(—CH(CH₃)—CH₂—O—)₉—(—CH₂—CH₂—O—)₁₋₁₀—, C₆-C₃₀-alkyl-O—(CH₂—CH₂—O)₁₋₁₀—(—CH(CH₃)—CH₂—O—)₁₀—(—CH₂—CH₂—O—)₁₋₁₀—.

More preferably Z₂ is selected from the group consisting of OH, ONa, OK, ONH₄, C₁₂-C₁₈-alkyl-O—(CH₂—CH₂—O)₁, C₁₂-C₁₈-alkyl-O—(CH₂—CH₂—O)₂, C₁₂-C₁₈-alkyl-O—(CH₂—CH₂—O)₃, C₁₂-C₁₈-alkyl-O—(CH₂—CH₂—O)₄, C₁₂-C₁₈-alkyl-O—(CH₂—CH₂—O)₅, C₁₂-C₁₈-alkyl-O—(CH₂—CH₂—O)₁₋₇—(—CH₂CH(CH₃)—O—)₁, C₁₂-C₁₈-alkyl-O—(CH₂—CH₂—O)₁₋₇—(—CH₂—CH(CH₃)—O—)₂, C₁₂-C₁₈-alkyl-O—(CH₂—CH₂—O)₁₋₇—(—CH(CH₃)—O—)₃, C₁₂-C₁₈-alkyl-O—(CH₂—CH₂—O)₁₋₇—(—CH₂CH(CH₃)—O—)₄, C₁₂-C₁₈-alkyl-O—(CH₂—CH₂—O)₁₋₇—(—CH₂—CH(CH₃)—O—)₅, C₁₂-C₁₈-alkyl-O—(CH₂—CH₂—O)₁₋₇—(—CH(CH₃)—CH₂—O—)₁, C₁₂-C₁₈-alkyl-O—(CH₂—CH₂—O)₁₋₇—(—CH(CH₃)—CH₂—O—)₂, C₁₂-C₁₈-alkyl-O—(CH₂—CH₂—O)₁₋₇—(—CH(CH₃)—CH₂—O—)₃, C₁₂-C₁₈-alkyl-O—(CH₂—CH₂—O)₁₋₇—(—CH(CH₃)—CH₂—O—)₄, C₁₂-C₁₈-alkyl-O—(CH₂—CH₂—O)₁₋₇—(—CH(CH₃)—CH₂O—)₅, C₁₂-C₁₈-alkyl-O—(CH₂—CH₂—O)₁₋₇—(—CH₂—CH(CH₃)—O—)₁—(—CH₂—CH₂—O—)₁₋₇—, C₁₂-C₁₈-alkyl-O—(CH₂—CH₂—O)₁₋₇—(—CH₂CH(CH₃)—O—)₂—(—CH₂—CH₂—O—)₁₋₇—, C₁₂-C₁₈-alkyl-O—(CH₂—CH₂—O)₁₋₇—(—CH₂—CH(CH₃)—O—)₃—(—CH₂—CH₂—O—)₁₋₇—, C₁₂-C₁₈-alkyl-O—(CH₂—CH₂—O)₁₋₇—(—CH₂—CH(CH₂)—O—)₄—(—CH₂—CH₂—O—)₁₋₇—, —C₁₂-C₁₈-alkyl-O—(CH₂—CH₂—O)₁₋₇—(—CH₂—CH(CH₃)—O—)₅—(—CH₂—CH₂—O—)₁₋₇—, C₁₂-C₁₈-alkyl-O—(CH₂—CH₂—O—)₁₋₇—(—CH(CH₃)—CH₂—O—)₁—(—CH₂—CH₂—O—)₁₋₇—, C₁₂-C₁₈-alkyl-O—(CH₂—CH₂—O)₁₋₇—(—CH(CH₃)—CH₂—O—)₂—(—CH₂—CH₂—O—)₁₋₇—, C₁₂-C₁₈-alkyl-O—(CH₂—CH₂—O)₁₋₇—(—CH(CH₃)—CH₂—O—)₃—(—CH₂—CH₂—O—)₁₋₇—, C₁₂-C₁₈-alkyl-O—(CH₂—CH₂—O)₁₋₇—(—CH(CH₃)—CH₂—O—)₄—(—CH₂—CH₂—O—)₁₋₇—, C₁₂-C₁₈-alkyl-O—(CH₂—CH₂—O)₁₋₇—(—CH(CH)—CH₂—O—)₅—(—CH₂—CH₂—O—)₁₋₇—.

In another preferred embodiment, the M and M₅ are H, ammonium or an alkali metal ion, wherein the alkali metal ion is preferably selected from ammonium, lithium, sodium, potassium and cesium; more preferably the alkali metal ion is sodium or potassium.

In another preferred embodiment, the sum of l+m+n is an integer in the range from ≥1 to ≤20, more preferably in the range from ≥1 to ≤12, most preferably in the range from ≥3 to ≤10, and in particular preferably in the range from ≥3 to ≤9.

In another preferred embodiment R³ and R⁴ are independently of each other selected from the group consisting of H and C₁-C₆-alkyl. The C₁-C₆-alkyl is preferably selected from the group consisting of methyl, ethyl, propyl, butyl, pentyl and hexyl. More preferably, alkyl is selected from the group consisting of methyl, ethyl, propyl, butyl and pentyl. Even more preferably, alkyl is selected from the group consisting of methyl, ethyl, propyl and butyl. Most preferably, alkyl is selected from the group consisting of methyl, ethyl and propyl. In particular preferably, alkyl is methyl.

### Component C

In another preferred embodiment, the at least one component C of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, diisononyladipate, pentyl hexanoate, heptyl hexanoate, octyl hexanoate, nonyl hexanoate, decyl hexanoate, undecyl hexanoate, dodecyl hexanoate, tridecyl hexanoate, tetradecyl hexanoate, penatdecyl hexanoate, hexadecyl hexanoate, heptadecyl hexanoate, octadecyl hexanoate, nonadecyl hexanoate, pentyl heptanoate, pentyl octanoate, pentyl nonanoate, pentyl decanoate, pentyl undecanoate, pentyl dodecanoate, pentyl tridecanoate, pentyl tetradecanoate, pentyl pentadecanoate, pentyl palmitate, pentyl heptadecanoate, pentyl stearate, pentyl nonadecanoate, pentyl icosanoate, hexyl heptanoate, hexyl octanoate, hexyl nonanoate, hexyl decanoate, hexyl undecanoate, hexyl dodecanoate, hexyl tridecanoate, hexyl tetradecanoate, hexyl pentadecanoate, hexyl palmitate, hexyl heptadecanoate, hexyl stearate, hexyl nonadecanoate, hexyl icosanoate, heptyl heptanoate, heptyl octanoate, heptyl nonanoate, heptyl decanoate, heptyl undecanoate, heptyl dodecanoate, heptyl tridecanoate, heptyl tetradecanoate, heptyl pentadecanoate, heptyl palmitate, heptyl heptadecanoate, heptyl stearate, heptyl nonadecanoate, heptyl icosanoate, octyl heptanoate, octyl octanoate, octyl nonanoate, octyl decanoate, octyl undecanoate, octyl dodecanoate, octyl tridecanoate, octyl tetradecanoate, octyl pentadecanoate, octyl palmitate, octyl heptadecanoate, octyl stearate, octyl nonadecanoate, octyl icosanoate, nonyl heptanoate, nonyl octanoate, nonyl nonanoate, nonyl decanoate, nonyl undecanoate, nonyl dodecanoate, nonyl tridecanoate, nonyl tetradecanoate, nonyl pentadecanoate, nonyl palmitate, nonyl heptadecanoate, nonyl stearate, nonyl nonadecanoate, nonyl icosanoate, decyl heptanoate, decyl octanoate, decyl nonanoate, decyl decanoate, decyl undecanoate, decyl dodecanoate, decyl tridecanoate, decyl tetradecanoate, decyl pentadecanoate, decyl palmitate, decyl heptadecanoate, decyl stearate, decyl nonadecanoate, decyl icosanoate, undecyl heptanoate, undecyl octanoate, undecyl nonanoate, undecyl decanoate, undecyl undecanoate, undecyl dodecanoate, undecyl tridecanoate, undecyl tetradecanoate, undecyl pentadecanoate, undecyl palmitate, undecyl heptadecanoate, undecyl stearate, undecyl nonadecanoate, undecyl icosanoate, dodecyl heptanoate, dodecyl octanoate, dodecyl nonanoate, dodecyl decanoate, dodecyl undecanoate, dodecyl dodecanoate, dodecyl tridecanoate, dodecyl tetradecanoate, dodecyl pentadecanoate, dodecyl palmitate, dodecyl heptadecanoate, dodecyl stearate, dodecyl nonadecanoate, dodecyl icosanoate, tridecyl heptanoate, tridecyl octanoate, tridecyl nonanoate, tridecyl decanoate, tridecyl undecanoate, tridecyl dodecanoate, tridecyl tridecanoate, tridecyl tetradecanoate, tridecyl pentadecanoate, tridecyl palmitate, tridecyl heptadecanoate, tridecyl stearate, tridecyl nonadecanoate, tridecyl icosanoate, tetradecyl heptanoate, tetradecyl octanoate, tetradecyl nonanoate, tetradecyl decanoate, tetradecyl undecanoate, tetradecyl dodecanoate, tetradecyl tridecanoate, tetradecyl tetradecanoate, tetradecyl pentadecanoate, tetradecyl palmitate, tetradecyl heptadecanoate, tetradecyl stearate, tetradecyl nonadecanoate, tetradecyl icosanoate, pentadecyl heptanoate, pentadecyl octanoate, pentadecyl nonanoate, pentadecyl decanoate, pentadecyl undecanoate, pentadecyl dodecanoate, pentadecyl tridecanoate, pentadecyl tetradecanoate, pentadecyl pentadecanoate, pentadecyl palmitate, pentadecyl heptadecanoate, pentadecyl stearate, pentadecyl nonadecanoate, pentadecyl icosanoate, hexadecyl heptanoate, hexadecyl octanoate, hexadecyl nonanoate, hexadecyl decanoate, hexadecyl undecanoate, hexadecyl dodecanoate, hexadecyl tridecanoate, hexadecyl tetradecanoate, hexadecyl pentadecanoate, hexadecyl palmitate, hexadecyl heptadecanoate, hexadecyl stearate, hexadecyl nonadecanoate, hexadecyl icosanoate, heptadecyl heptanoate, heptadecyl octanoate, heptadecyl nonanoate, heptadecyl decanoate, heptadecyl undecanoate, heptadecyl dodecanoate, heptadecyl tridecanoate, heptadecyl tetradecanoate, heptadecyl pentadecanoate, heptadecyl palmitate, heptadecyl heptadecanoate, heptadecyl stearate, heptadecyl nonadecanoate, heptadecyl icosanoate, octadecyl heptanoate, octadecyl octanoate, octadecyl nonanoate, octadecyl decanoate, octadecyl undecanoate, octadecyl dodecanoate, octadecyl tridecanoate, octadecyl tetradecanoate, octadecyl pentadecanoate, octadecyl palmitate, octadecyl heptadecanoate, octadecyl stearate, octadecyl nonadecanoate, octadecyl icosanoate, nonadecyl heptanoate, nonadecyl octanoate, nonadecyl nonanoate, nonadecyl decanoate, nonadecyl undecanoate, nonadecyl dodecanoate, nonadecyl tridecanoate, nonadecyl tetradecanoate, nonadecyl pentadecanoate, nonadecyl palmitate, nonadecyl heptadecanoate, nonadecyl stearate, nonadecyl nonadecanoate, nonadecyl icosanoate, icosyl heptanoate, icosyl octanoate, icosyl nonanoate, icosyl decanoate, icosyl undecanoate, icosyl dodecanoate, icosyl tridecanoate, icosyl tetradecanoate, icosyl pentadecanoate, icosyl palmitate, icosyl heptadecanoate, icosyl stearate, icosyl nonadecanoate, icosyl icosanoate, dimethyl adipate, diethyl adipate, dipropyl adipate, dibutyl adipate, dipentyl adipate, dihexyl adipate, diheptyl adipate, dioctyl adipate, dinonyl adipate, didecyl adipate, diundecyl adipate, didodecyl adipate, ditridecyl adipate, ditetra adipate, sodium 6-methoxy-6-oxohexanoate, sodium 6-ethoxy-6-oxohexanoate, sodium 6-oxo-6-propoxyhexanoate, sodium 6-butoxy-6-oxohexanoate, sodium 6-oxo-6-(pentyloxy)hexanoate, sodium 6-(hexyloxy)-6-oxohexanoate, sodium 6-(heptyloxy)-6-oxohexanoate, sodium 6-(octyloxy)-6-oxohexanoate, sodium 6-(nonyloxy)-6-oxohexanoate and sodium 6-(decyloxy)-6-oxohexanoate; more preferably the compound of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, and diisononyladipate.

In another preferred embodiment, the at least one component C of formula (III) is selected from the group consisting of heptane-1-sulfonic acid, octane-1-sulfonic acid, nonane-1-sulfonic acid, decane-1-sulfonic acid, undecane-1-sulfonic acid, dodecane-1-sulfonic acid, tridecane-1-sulfonic acid, tetradecane-1-sulfonic acid, pentadecane-1-sulfonic acid, heaxadecane-1-sulfonic acid, heptadecane-1-sulfonic acid, octadecane-1-sulfonic acid, nonadecane-1-sulfonic acid, icosane-1-sulfonic acid, sodium heptane-1-sulfonate, sodium octane-1-sulfonate, sodium nonane-1-sulfonate, sodium decane-1-sulfonate, sodium undecane-1-sulfonate, sodium dodecane-1-sulfonate, tridecane-1-sulfonate, sodium tetradecane-1-sulfonate, sodium pentadecane-1-sulfonate, sodium heaxadecane-1-sulfonate, sodium heptadecane-1-sulfonate, sodium octadecane-1-sulfonate, nonadecane-1-sulfonate, sodium icosane-1-sulfonate, potassium heptane-1-sulfonate, potassium octane-1-sulfonate, potassium nonane-1-sulfonate, potassium decane-1-sulfonate, potassium undecane-1-sulfonate, potassium dodecane-1-sulfonate, tridecane-1-sulfonate, potassium tetradecane-1-sulfonate, potassium pentadecane-1-sulfonate, potassium heaxadecane-1-sulfonate, potassium heptadecane-1-sulfonate, potassium octadecane-1-sulfonate, nonadecane-1-sulfonate, potassium icosane-1-sulfonate, butyl heptane-1-sulfonate, pentyl heptane-1-sulfonate, hexyl heptane-1-sulfonate, heptyl heptane-1-sulfonate, octyl heptane-1-sulfonate, nonyl heptane-1-sulfonate, butyl octane-1-sulfonate, pentyl octane-1-sulfonate, hexyl octane-1-sulfonate, heptyl octane-1-sulfonate, octyl octane-1-sulfonate, nonyl octane-1-sulfonate, decyl octane-1-sulfonate, dodecyl octane-1-sulfonate, pentadecayl octane-1-sulfonate, hexadecyl octane-1-sulfonate, butyl undecane-1-sulfonate, pentyl undecane-1-sulfonate, ethyl undecane-1-sulfonate, propyl undecane-1-sulfonate, hexyl undecane-1-sulfonate, heptyl undecane-1-sulfonate, methyl dodecane-1-sulfonate, ethyl dodecane-1-sulfonate, propyl dodecane-1-sulfonate, butyl dodecane-1-sulfonate, pentyl dodecane-1-sulfonate, hexyl dodecane-1-sulfonate, methyl tridecane-1-sulfonate, ethyl tridecane-1-sulfonate, propyl tridecane-1-sulfonate, butyl tridecane-1-sulfonate, pentyl tridecane-1-sulfonate, hexyl tridecane-1-sulfonate, sodium heptane-1-sulfate, sodium octane-1-sulfate, sodium nonane-1-sulfate, sodium decane-1-sulfate, sodium undecane-1-sulfate, sodium dodecane-1-sulfate, tridecane-1-sulfate, sodium tetradecane-1-sulfate, sodium pentadecane-1-sulfate, sodium heaxadecane-1-sulfate, sodium heptadecane-1-sulfate, sodium octadecane-1-sulfate, nonadecane-1-sulfate, sodium icosane-1-sulfate, potassium heptane-1-sulfate, potassium octane-1-sulfate, potassium nonane-1-sulfate, potassium decane-1-sulfate, potassium undecane-1-sulfate, potassium dodecane-1-sulfate, tridecane-1-sulfate, potassium tetradecane-1-sulfate, potassium pentadecane-1-sulfate, potassium heaxadecane-1-sulfate, potassium heptadecane-1-sulfate, potassium octadecane-1-sulfate, nonadecane-1-sulfate, potassium icosane-1-sulfate, butyl heptane-1-sulfate, pentyl heptane-1-sulfate, hexyl heptane-1-sulfate, heptyl heptane-1-sulfate, octyl heptane-1-sulfate, nonyl heptane-1-sulfate, butyl octane-1-sulfate, pentyl octane-1-sulfate, hexyl octane-1-sulfate, heptyl octane-1-sulfate, octyl octane-1-sulfate, nonyl octane-1-sulfate, decyl octane-1-sulfate, dodecyl octane-1-sulfate, pentadecayl octane-1-sulfate, hexadecyl octane-1-sulfate, butyl undecane-1-sulfate, pentyl undecane-1-sulfate, ethyl undecane-1-sulfate, propyl undecane-1-sulfate, hexyl undecane-1-sulfate, heptyl undecane-1-sulfate, methyl dodecane-1-sulfate, ethyl dodecane-1-sulfate, propyl dodecane-1-sulfate, butyl dodecane-1-sulfate, pentyl dodecane-1-sulfate, hexyl dodecane-1-sulfate, methyl tridecane-1-sulfate, ethyl tridecane-1-sulfate, propyl tridecane-1-sulfate, butyl tridecane-1-sulfate, pentyl tridecane-1-sulfate, hexyl tridecane-1-sulfate, C₁₀H₂₁O(CH₂CH₂O)₁₋₁₀S(═O)₂OM₂, C₁₁H₂₃O(CH₂CH₂O)₁₋₁₀S(═O)₂OM₂, C₁₂H₂₅O(CH₂CH₂O)₁₋₁₀S(═O)₂OM₂, C₁₃H₂₇O(CH₂CH₂O)₁₋₁₀S(═O)₂OM₂, C₁₄H₂₉O(CH₂CH₂O)₁₋₁₀S(═O)₂OM₂, C₁₅H₃₁O(CH₂CH₂O)₁₋₁₀S(═O)₂OM₂, C₁₀H₂₁O(CH₂CH(CH₃)O)₁₋₁₀S(═O)₂OM₂, C₁₁H₂₃O(CH₂CH(CH₃)O)₁₋₁₀S(═O)₂OM₂, C₁₂H₂₅O(CH₂CH(CH₃)O)₁₋₁₀S(═O)₂OM₂, C₁₃H₂₇O(CH₂CH(CH₃)O)₁₋₁₀S(═O)₂OM₂, C₁₄H₂₉O(CH₂CH(CH₃)O)₁₋₁₀S(═O)₂OM₂, C₁₅H₃₁O(CH₂CH(CH₃)O)₁₋₁₀S(═O)₂OM₂, C₁₀H₂₁O(CH(CH₃)CH₂O)₁₋₁₀S(═O)₂OM₂, C₁₁H₂₃O(CH(CH₃)CH₂O)₁₋₁₀S(═O)₂OM₂, C₁₂H₂₅O(CH(CH₃)CH₂O)₁₋₁₀S(═O)₂OM₂, C₁₃H₂₇O(CH(CH₃)CH₂O)₁₋₁₀S(═O)₂OM₂, C₁₄H₂₉O(CH(CH₃)CH₂O)₁₋₁₀S(═O)₂OM₂, C₁₅H₃₁O(CH(CH₃)CH₂O)₁₋₁₀S(═O)₂OM₂, C₁₀H₁₉O(CH₂CH₂O)₁₋₁₀S(═O)₂OM₂, C₁₁H₂₁O(CH₂CH₂O)₁₋₁₀S(═O)₂OM₂, C₁₂H₂₃O(CH₂CH₂O)₁₋₁₀S(═O)₂OM₂, C₁₃H₂₅O(CH₂CH₂O)₁₋₁₀S(═O)₂OM₂, C₁₄H₂₇O(CH₂CH₂O)₁₋₁₀S(═O)₂OM₂, C₁₅H₂₉O(CH₂CH₂O)₁₋₁₀S(═O)₂OM₂; C₁₆H₃₃O(CH₂CH₂O)₁₋₁₀S(═O)₂OM₂, C₁₆H₃₃O(CH₂CH(CH₃)O)₁₋₁₀S(═O)₂OM₂, C₁₆H₃₃O(CH(CH₃)CH₂O)₁₋₁₀S(═O)₂OM₂, C₁₆H₃₁O(CH₂CH₂O)₁₋₁₀S(═O)₂OM₂, C₁₆H₃₁O(CH₂CH(CH)O)₁₋₁₀S(═O)₂OM₂, C₁₆H₃₁O(CH(CH₃)CH₂O)₁₋₁₀S(═O)₂OM₂, C₁₇H₃₅O(CH₂CH₂O)₁₋₁₀S(═O)₂OM₂, C₁₇H₃₅O(CH₂CH(CH₃)O)₁₋₁₀S(═O)₂OM₂, C₁₇H₃₅O(CH(CH₃)CH₂O)₁₋₁₀S(═O)₂OM₂, C₁₇H₃₃O(CH₂CH₂O)₁₋₁₀S(═O)₂OM₂, C₁₇H₃₃O(CH₂CH(CH)O)₁₋₁₀S(═O)₂OM₂, C₁₇H₃₃O(CH(CH₃)CH₂O)₁₋₁₀S(═O)₂OM₂, C₁₈H₃₇O(CH₂CH₂O)₁₋₁₀S(═O)₂OM₂, C₁H₃₇O(CH₂CH(CH₃)O)₁₋₁₀S(═O)₂OM₂, C₁₈H₃₇O(CH(CH₃)CH₂O)₁₋₁₀S(═O)₂OM₂, C₁₈H₃₅O(CH₂CH₂O)₁₋₁₀S(═O)₂OM₂, C₁₈H₃₅O(CH₂CH(CH)O)₁₋₁₀S(═O)₂OM₂, C₁₈H₃₅O(CH(CH₃)CH₂O)₁₋₁₀S(═O)₂OM₂, C₁₈H₃₃O(CH₂CH₂O)₁₋₁₀S(═O)₂OM₂, C₁₈H₃₃O(CH₂CH(CH₃)O)₁₋₁₀S(═O)₂OM₂, C₁₈H₃₃O(CH(CH₃)CH₂O)₁₋₁₀S(═O)₂OM₂, wherein M₂ is selected from the group consisting of H, Na and K.

In another preferred embodiment, the at least one component C of formula (IV) is selected from the group consisting of (C₉H₁₉O(CH₂CH₂O)₁₋₁₀)₂P(═O)OM₃, (C₁₀H₂₁O(CH₂CH₂O)₁₋₁₀)₂P(═O)OM₃, (C₁₁H₂₃O(CH₂CH₂O)₁₋₁₀)₂P(═O)OM₃, (C₁₂H₂₅O(CH₂CH₂O)₁₋₁₀)₂P(═O)OM₃, (C₁₃H₂₇O(CH₂CH₂O)₁₋₁₀)₂P(═O)OM₃, (C₁₄H₂₉O(CH₂CH₂O)₁₋₁₀)₂P(═O)OM₃, (C₁₅H₃₁O(CH₂CH₂O)₁₋₁₀)₂P(═O)OM₃, (C₁₆H₃₃O(CH₂CH₂O)₁₋₁₀)₂P(═O)OM₃, (C₁₇H₃₅O(CH₂CH₂O)₁₋₁₀)₂P(═O)OM₃, (C₁₈H₃₇O(CH₂CH₂O)₁₋₁₀)₂P(═O)OM₃, (C₁₉H₃₉O(CH₂CH₂O)₁₋₁₀)₂P(═O)OM₃, (C₂₀H₄₁O(CH₂CH₂O)₁₋₁₀)₂P(═O)OM₃, (C₁₂H₂₅O(CH₂CH₂O)₁₋₁₀(CH₂CH(CH₃)O)₃)₂P(═O)OM₃, (C₁₃H₂₇O(CH₂CH₂O)₁₋₁₀ (CH₂CH(CH₃)O)₃)₂P(═O)OM₃, (C₁₄H₂₉O(CH₂CH₂O)₁₋₁₀(CH₂CH(CH)O)₃)₂P(═O)OM₃, (C₁₅H₃₁O(CH₂CH₂O)₁₋₁₀(CH₂CH(CH₃)O)₃)₂P(═O)OM₃, (C₁₆H₃₃O(CH₂CH₂O)₁₋₁₀(CH₂CH(CH₃)O)₃)₂P(═O)OM₃, (C₁₂H₂₅O(CH₂CH₂O)₁₋₁₀(CH₂CH(CH₃)O)₂)₂P(═O)OM₃, (C₁₃H₂₉O(CH₂CH₂O)₁₋₁₀ (CH₂CH(CH₃)O)₂)₂P(═O)OM₃, (C₁₄H₂₉O(CH₂CH₂O)₁₋₁₀(CH₂CH(CH₃)O)₂)₂P(═O)OM₃, (C₁₅H₃₁O(CH₂CH₂O)₁₋₁₀ (CH₂CH(CH₃)O)₂)₂P(═O)OM₃, (C₁₆H₃₃O(CH₂CH₂O)₁₋₁₀(CH₂CH(CH₃)O)₂)₂P(═O)OM₃, (C₁₈H₃₉O(CH₂CH₂O)₁₋₁₀ (CH₂CH(CH₃)O)₂)₂P(═O)OM₃, (C₁₂H₂₅O(CH₂CH₂O)₁₋₁₀(CH₂CH(CH₃)O)₄)₂P(═O)OM₃, (C₁₃H₂₉O(CH₂CH₂O)₁₋₁₀ (CH₂CH(CH₃)O)₄)₂P(═O)OM₃, (C₁₄H₂₉O(CH₂CH₂O)₁₋₁₀(CH₂CH(CH₃)O)₄)₂P(═O)OM₃, (C₁₅H₃₁O(CH₂CH₂O)₁₋₁₀(CH₂CH(CH₃)O)₄)₂P(═O)OM₃, (C₁₆H₃₃O(CH₂CH₂O)₁₋₁₀(CH₂CH(CH₃)O)₄)₂P(═O)OM₃, (C₁₈H₃₉O(CH₂CH₂O)₁₋₁₀ (CH₂CH(CH₃)O)₄)₂P(═O)OM₃, (C₁₂H₂₅O(CH₂CH₂O)₁₋₁₀(CH(CH₃)CH₂O)₃)₂P(═O)OM₃, (C₁₃H₂₉O(CH₂CH₂O)₁₋₁₀ (CH(CH₃)CH₂O)₃)₂P(═O)OM₃, (C₁₄H₂₉O(CH₂CH₂O)₁₋₁₀(CH(CH₃)CH₂O)₃)₂P(═O)OM₃, (C₁₅H₃₁O(CH₂CH₂O)₁₋₁₀ (CH(CH₃)CH₂O)₃)₂P(═O)OM₃, (C₁₆H₃₃O(CH₂CH₂O)₁₋₁₀(CH(CH₃)CH₂O)₃)₂P(═O)OM₃, (C₁₈H₃₉O(CH₂CH₂O)₁₋₁₀(CH(CH₃)CH₂O)₃)₂P(═O)OM₃, (C₁₂H₂₅O(CH₂CH₂O)₁₋₁₀(CH(CH₃)CH₂O)₂)₂P(═O)OM₃, (C₁₃H₂₉O(CH₂CH₂O)₁₋₁₀(CH(CH₃)CH₂O)₂)₂P(═O)OM₃, (C₁₄H₂₉O(CH₂CH₂O)₁₋₁₀(CH(CH₃)CH₂O)₂)₂P(═O)OM₃, (C₁₅H₃₁O(CH₂CH₂O)₁₋₁₀(CH(CH₃)CH₂O)₂)₂P(═O)OM₃, (C₁₆H₃₃O(CH₂CH₂O)₁₋₁₀(CH(CH₃)CH₂O)₂)₂P(═O)OM₃, (C₁H₃₉O(CH₂CH₂O)₁₋₁₀(CH(CH₃)CH₂O)₂)₂P(═O)OM₃, (C₁₂H₂₅O(CH₂CH₂O)₁₋₁₀(CH(CH₃)CH₂O)₄)₂P(═O)OM₃, (C₁₃H₂₉O(CH₂CH₂O)₁₋₁₀(CH(CH₃)CH₂O)₄)₂P(═O)OM₃, (C₁₄H₂₉O(CH₂CH₂O)₁₋₁₀(CH(CH₃)CH₂O)₄)₂P(═O)OM₃, (C₁₅H₃₁O(CH₂CH₂O)₁₋₁₀(CH(CH₃)CH₂O)₄)₂P(═O)OM₃, (C₁₆H₃₃O(CH₂CH₂O)₁₋₁₀(CH(CH₃)CH₂O)₄)₂P(═O)OM₃, (C₁₈H₃₉O(CH₂CH₂O)₁₋₁₀(CH(CH₃)CH₂O)₄)₂P(═O)OM₃, (C₉H₁₉O(CH₂CH₂O)₁₋₁₀)P(═O)(OM₃)(OM₆), (C₁₀H₂₁O(CH₂CH₂O)₁₋₁₀)P(═O)(OM₃)(OM₆), (C₁₁H₂₃O(CH₂CH₂O)₁₋₁₀)P(═O)(OM₃)(OM₆), (C₁₂H₂₅O(CH₂CH₂O)₁₋₁₀)P(═O)(OM₃)(OM₆), (C₁₃H₂₇O(CH₂CH₂O)₁₋₁₀)P(═O)(OM₃)(OM₆), (C₁₄H₂₉O(CH₂CH₂O)₁₋₁₀)P(═O)(OM₃)(OM₆), (C₁₅H₃₁O(CH₂CH₂O)₁₋₁₀)P(═O)(OM₃)(OM₆), (C₁₆H₃₃O(CH₂CH₂O)₁₋₁₀)P(═O)(OM₃)(OM₆), (C₁₇H₃₅O(CH₂CH₂O)₁₋₁₀)P(═O)(OM₃)(OM₆), (C₁₈H₃₇O(CH₂CH₂O)₁₋₁₀)P(═O)(OM₃)(OM₆), (C₁₉H₃₉O(CH₂CH₂O)₁₋₁₀)P(═O)(OM₃)(OM₆), (C₂₀H₄₁O(CH₂CH₂O)₁₋₁₀)P(═O)(OM₃)(OM₆), (C₁₂H₂₅O(CH₂CH₂O)₁₋₁₀(CH₂CH(CH₃)O)₃)P(═O)(OM₃)(OM₆), (C₁₃H₂₇O(CH₂CH₂O)₁₋₁₀(CH₂CH(CH₃)O)₃)P(═O)(OM₃)(OM₆), (C₁₄H₂₉O(CH₂CH₂O)₁₋₁₀(CH₂CH(CH₃)O)₃)P(═O)(OM₃)(OM₆), (C₁₅H₃₁O(CH₂CH₂O)₁₋₁₀(CH₂CH(CH₃)O)₃)P(═O)(OM₃)(OM₆), (C₁₆H₃₃O(CH₂CH₂O)₁₋₁₀(CH₂CH(CH₃)O)₃)P(═O)(OM₃)(OM₆), (C₁₂H₂₅O(CH₂CH₂O)₁₋₁₀(CH₂CH(CH₃)O)₂)P(═O)(OM₃)(OM₆), (C₁₃H₂₉O(CH₂CH₂O)₁₋₁₀(CH₂CH(CH₃)O)₂)P(═O)(OM₃)(OM₆), (C₁₄H₂₉O(CH₂CH₂O)₁₋₁₀(CH₂CH(CH₃)O)₂)P(═O)(OM₃)(OM₆), (C₁₅H₃₁O(CH₂CH₂O)₁₋₁₀(CH₂CH(CH₃)O)₂)P(═O)(OM₃)(OM₆), (C₁₆H₃₃O(CH₂CH₂O)₁₋₁₀(CH₂CH(CH₃)O)₂)P(═O)(OM₃)(OM₆), (C₁₈H₃₉O(CH₂CH₂O)₁₋₁₀(CH₂CH(CH₃)O)₂)P(═O)(OM₃)(OM₆), (C₁₂H₂₅O(CH₂CH₂O)₁₋₁₀(CH₂CH(CH₃)O)₄)P(═O)(OM₃)(OM₆), (C₁₃H₂₉O(CH₂CH₂O)₁₋₁₀(CH₂CH(CH₃)O)₄)P(═O)(OM₃)(OM₆), (C₁₄H₂₉O(CH₂CH₂O)₁₋₁₀(CH₂CH(CH₃)O)₄)P(═O)(OM₃)(OM₆), (C₁₅H₃₁O(CH₂CH₂O)₁₋₁₀(CH₂CH(CH₃)O)₄)P(═O)(OM₃)(OM₆), (C₁₆H₃₃O(CH₂CH₂O)₁₋₁₀(CH₂CH(CH₃)O)₄)P(═O)(OM₃)(OM₆), (C₁₈H₃₉O(CH₂CH₂O)₁₋₁₀(CH₂CH(CH₃)O)₄)P(═O)(OM₃)(OM₆), (C₁₂H₂₅O(CH₂CH₂O)₁₋₁₀(CH(CH₃)CH₂O)₃)P(═O)(OM₃)(OM₆), (C₁₃H₂₉O(CH₂CH₂O)₁₋₁₀(CH(CH)CH₂O)₃)P(═O)(OM₃)(OM₆), (C₁₄H₂₉O(CH₂CH₂O)₁₋₁₀(CH(CH)CH₂O)₃)P(═O)(OM₃)(OM₆), (C₁₅H₃₁O(CH₂CH₂O)₁₋₁₀(CH(CH)CH₂O)₃)P(═O)(OM₃)(OM₆), (C₁₆H₃₃O(CH₂CH₂O)₁₋₁₀(CH(CH)CH₂O)₃)P(═O)(OM₃)(OM₆), (C₁₈H₃₉O(CH₂CH₂O)₁₋₁₀(CH(CH)CH₂O)₃)P(═O)(OM₃)(OM₆), (C₁₂H₂₅O(CH₂CH₂O)₁₋₁₀(CH(CH)CH₂O)₂)P(═O)(OM₃)(OM₆), (C₁₃H₂₉O(CH₂CH₂O)₁₋₁₀(CH(CH)CH₂O)₂)P(═O)(OM₃)(OM₆), (C₁₄H₂₉O(CH₂CH₂O)₁₋₁₀(CH(CH)CH₂O)₂)P(═O)(OM₃)(OM₆), (C₁₅H₃₁O(CH₂CH₂O)₁₋₁₀(CH(CH₃)CH₂O)₂)P(═O)(OM₃)(OM₆), (C₁₆H₃₃O(CH₂CH₂O)₁₋₁₀(CH(CH)CH₂O)₂)P(═O)(OM₃)(OM₆), (C₁₈H₃₉O(CH₂CH₂O)₁₋₁₀(CH(CH)CH₂O)₂)P(═O)(OM₃)(OM₆), (C₁₂H₂₅O(CH₂CH₂O)₁₋₁₀(CH(CH)CH₂O)₄)P(═O)(OM₃)(OM₆), (C₁₃H₂₉O(CH₂CH₂O)₁₋₁₀(CH(CH)CH₂O)₄)P(═O)(OM₃)(OM₆), (C₁₄H₂₉O(CH₂CH₂O)₁₋₁₀(CH(CH₃)CH₂O)₄)P(═O)(OM₃)(OM₆), (C₁₅H₃₁O(CH₂CH₂O)₁₋₁₀(CH(CH)CH₂O)₄)P(═O)(OM₃)(OM₆), (C₁₆H₃₃O(CH₂CH₂O)₁₋₁₀(CH(CH)CH₂O)₄)P(═O)(OM₃)(OM₆), (C₁₈H₃₉O(CH₂CH₂O)₁₋₁₀(CH(CH₃)CH₂O)₄)P(═O)(OM₃)(OM₆); wherein M₃ and M₆ are independently selected from the group consisting of H, Na and K.

Within the context of the presently claimed invention the term alkyl or alkenyl refers to linear or branched alkyl or alkenyl with the degree of branching (iso-index) from ≥1 to ≤4.

In another embodiment, the presently claimed invention is directed to a direct flotation process for the beneficiation of phosphates from phosphate-containing mineral comprising the steps of:
a) grinding phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting of the phosphate in the froth;
   wherein the collector composition comprises:
i. at least one component A, and
ii. at least one component B,
   wherein the at least one component A comprises saturated or unsaturated C₈-C₂₂ fatty acids or derivatives thereof containing at least one C(═O)—OH group or salts thereof, and the at least one component B is a compound of formula (I),

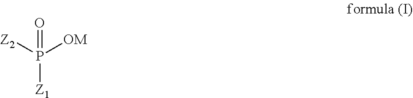

wherein Z₁, Z₂ and M is as defined as above.

In another embodiment, the presently claimed invention is directed to a reverse flotation process for the beneficiation of the phosphate-containing mineral by collection of impurities from phosphate-containing mineral in the froth, comprising the steps of:
a) grinding the phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting carbonate and/or other impurities in the froth, and
g) recovering the phosphates.

In another preferred embodiment, flotation process for the beneficiation of phosphates from phosphate-containing mineral, wherein the composition further comprises at least one component C of formula (II) or formula (III) or formula (IV), which is in each case different from the at least one component A and the at least one component B,

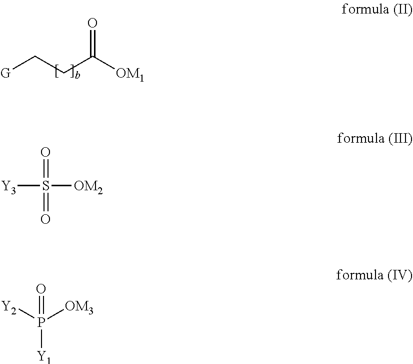

wherein G, b, Y₁, Y₂, Y₃, M₁, M₂ and M₃ are as defined as above.

In another preferred embodiment, the flotation process, both direct and reverse, comprises the step of adding one or more modifiers and/or one or more frothers and/or one or more depressants before step c).

In another preferred embodiment, the modifiers are selected from the group consisting of pH modifiers such as sulfuric acid, phosphoric acid, hydrochloric acid, hexafluorosilicic acid, ammonia, sodium hydroxide, sodium carbonate.

In another preferred embodiment, the depressants/dispersants are selected from the group consisting of sodium silicate, potassium silicate, sodium polyacrylate, sodium (di)hydrogenphosphate, sodium pyrophosphate, sodium metapolyphosphate, starch (straight or gelatinized with NaOH), other natural polysaccharides such as guar gum, dextrin, lignine sulfonate, natural tannins e.g. quebracho extract, sulfonated tannins, poly(ethylene)oxides etc.

In another preferred embodiment, the frothers are selected from the group consisting of pine oil, aliphatic alcohols such as MIBC (methyl isobutyl carbinol), polyglycols, polyglycol ethers, polypropylene glycol ethers, polyoxyparafins, cresylic acid (Xylenol), distillate bottoms of 2-ethyl hexanol, 2 ethyl hexanol, n-butanol, 2-methyl-2-butanol, isononyl alcohol, isodecyl alcohol, by products of hydroformylation of propene and mixtures thereof; More preferably, the frothing agent is MIBC (methyl isobutyl carbinol), distillate bottoms of 2-ethyl hexanol, n-butanol, 2-methyl-2-butanol, isononyl alcohol or isodecyl alcohol.

In a most preferred embodiment, the frothing agent is distillate bottoms of 2-ethyl hexanol.

In another preferred embodiment, the depressants are selected from the group consisting of poly(ethylene) oxide, polycarboxylate ethers, sodium polyacrylate, polysaccharides, starch, cellulose derivatives, and tannic acid.

In another preferred embodiment, the phosphate-containing minerals are pretreated to remove silicates. The pretreatment of the minerals before direct flotation and/or reverse flotation means, the mineral may be crushed or ground to finer particles. For the froth flotation then the targeted mineral, in particular phosphates in case of direct flotation and in particular carbonates and/or silicates or other impurities in case of reverse flotation, is rendered hydrophobic by addition of the collector composition. The targeted minerals can either be collected in the froth (direct flotation) or remain in the slurry as cell product (reverse flotation). Flotation can be undertaken in several stages/cycles to maximize the recovery of the desired mineral and to maximize the concentration of the desired mineral. Surprisingly, by addition of the collector composition of the present invention the number of stages/cycles can be reduced while achieving the same grade as with more stages/cycles.

In another preferred embodiment, the phosphate-containing mineral particles have a size in the range of 0.001 to 1 mm determined according to sieve tower method or laser granulometry method.

In another preferred embodiment, the amount of the collector composition is in the range of 10 g to 10 Kg per 1000 kg phosphate mineral; more preferably 10 g to 8 kg per 1000 kg phosphate mineral; even more preferably 50 g to 5 kg per 1000 kg phosphate mineral; most preferably 50 g to 3 kg per 1000 kg phosphate mineral; and in particular preferably 50 g to 1 kg per 1000 kg phosphate mineral.

In an embodiment, the presently claimed invention is directed to a collector composition for the beneficiation of phosphates from phosphate-containing mineral comprising
at least one component A,
at least one component B, and
at least one component C,
   wherein the at least one component A comprises saturated or unsaturated C₈-C₂₂ fatty acids or derivatives thereof containing at least one C(═O)—OH group or salts thereof, and the at least one component B is a compound of formula (I),

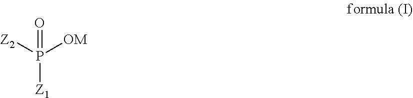

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl;
   wherein the at least one component C is selected from the group consisting of formula (II), formula (III) and formula (IV), which is in each case different from the at least one A and the at least one component B,

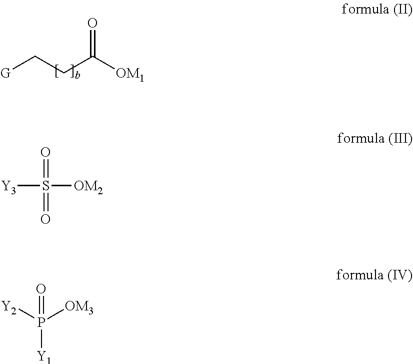

wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.

In another preferred embodiment, the presently claimed invention is directed to a collector composition, wherein the at least one component A comprises saturated or unsaturated C₁₂-C₁₈ fatty acids or derivatives thereof containing at least one C(═O)—OH group or a salt thereof.

In another preferred embodiment, the presently claimed invention is directed to a collector composition, wherein the at least one component A comprises saturated or unsaturated C₁₆-C₁₈ fatty acids or derivatives thereof containing at least one C(═O)—OH group or a salt thereof.

In another preferred embodiment, the presently claimed invention is directed to a collector composition, wherein the at least one component B is a compound of formula (I),

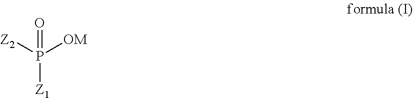

wherein
Z₁ is C₈-C₂₂-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₈-C₂₂-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10, and
R³ and R⁴ are independently of each other selected from H and methyl.

In another preferred embodiment, the at least one component A is selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, isostearic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.

In another preferred embodiment, the collector composition comprises at least one component C is selected from the group consisting of formula (II), r formula (III) and formula (IV), which is in each case different from the at least one component A and the at least one component B,

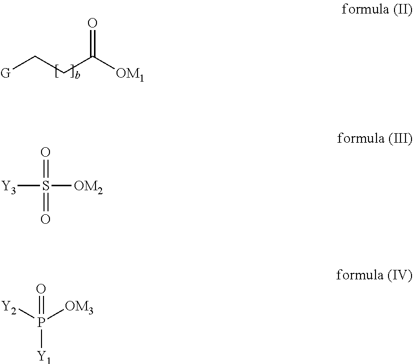

wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ(—CH₂—CH₂—O—)ₘ—,
Y₂ and Y₃ are independently selected from the group consisting of C₁-C₂₄ alkyl, C₂-C₂₄ alkenyl, OR and C₆-C₃-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.

In another preferred embodiment, the compound of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, and diisononyladipate.

In another preferred embodiment, the compound of formula (III),
M₂ is an alkali metal ion,
Y₃ is C₁₀-C₂₀-alkyl-O—(CH₂—CH₂—O)ₙ—(—CH(R³)—CH(R⁴)—O—)ₗ(—CH₂—CH₂—O—)ₘ—,
n is an integer in the range from ≥1 to ≤6,
l is an integer in the range from ≥0 to ≤10,
m is an integer in the range from ≥0 to ≤10,
the sum of l+m+n is an integer in the range from ≥1 to ≤10, and
R³ and R⁴ are independently of each other selected from H and methyl.

In another preferred embodiment, the compound of formula (IV),
Y₁ is C₈-C₂₂-alkyl-O—(CH₂—CH₂—O)ₙ—(—CH(R³)—CH(R⁴)—O—)ₗ(—CH₂—CH₂—O—)ₘ—;
Y₂ is selected from OM₆ and C₈-C₂₂-alkyl-O—(CH₂—CH₂—O)ₙ—(—CH(R³)—CH(R⁴)—O—)ₗ—(—CH₂—CH₂—O—)ₘ—;
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10,
M₃ and M₆ each are independently selected from the group consisting of alkali metal ions, H, C₁-C₂₄ alkyl and C₂-C₂₄ alkenyl with a branching degree between 0 and 4; and
R³ and R⁴ are independently of each other selected from H and methyl.

In another preferred embodiment, the amount of the at least one component A is in the range from ≥50 wt. % to ≤99.9 wt. %, based on the total weight of the collector composition, more preferably is in the range from ≥50 wt. % to ≤90 wt. %; even more preferably is in the range from ≥50 wt. % to ≤80 wt. %; most preferably is in the range from ≥60 wt. % to ≤80 wt. %; and in particular preferably is in the range from ≥65 wt. % to ≤75 wt. % based on the total weight of the collector composition.

In another preferred embodiment, the amount of the at least one component B is in the range from ≥0.1 wt. % to ≤50 wt. %, based on the total weight of the collector composition; more preferably is in the range from ≥5 wt. % to ≤50 wt. %; even more preferably is in the range from ≥10 wt. % to ≤40 wt. %; most preferably is in the range from ≥10 wt. % to ≤40 wt. %; and in particular preferably is in the range from ≥15 wt. % to ≤35 wt. %, based on the total weight of the collector composition.

In another preferred embodiment, the amount of the at least one component B is in the range from ≥10 wt. % to ≤35 wt. %, based on the total weight of the collector composition.

In another preferred embodiment, the amount of the at least one component C is in the range from ≥0.1 wt. % to ≤20 wt. %, based on the total weight of the collector composition preferably is in the range from ≥1 wt. % to ≤20 wt. %; more preferably is in the range from ≥5 wt. % to ≤20 wt. %; and most preferably is in the range from ≥10 wt. % to ≤20 wt. %. In another preferred embodiment, the collector composition comprises the at least one component A in an amount in the range of ≥50 wt. % to ≤90 wt. % and the at least one component B in an amount of ≥5 wt. % to ≤35 wt. %, based on the total weight of the collector composition.

In another preferred embodiment, the collector composition comprises the at least one component A in an amount in the range of ≥50 wt. % to ≤75 wt. % and the at least one component B in an amount of ≥15 wt. % to ≤35 wt. %, based on the total weight of the collector composition.

In another preferred embodiment, the collector composition comprises the at least one component A in an amount in the range of ≥50 wt. % to ≤90 wt. %, the at least one component B in an amount of ≥5 wt. % to ≤35 wt. % and the at least one component C in an amount in the range of ≥0.1 wt. % to ≤20 wt. %, based on the total weight of the collector composition.

In another preferred embodiment, the collector composition comprises the at least one component A in an amount in the range of ≥50 wt. % to ≤75 wt. %, the at least one component B in an amount of ≥15 wt. % to ≤35 wt. % and the at least one component C in an amount in the range of ≥10 wt. % to ≤20 wt. %, based on the total weight of the collector composition.

In another preferred embodiment, the collector composition comprises additives and/or modifier in an amount is in the range from 0% to 10%, preferably in the range from 0.2% to 8%, more preferably in the range from 0.4% to 6% and most preferably in the range from 0.5% to 5%.

In another preferred embodiment, the collector composition comprises the at least one component A in an amount in the range of ≥50 wt. % to ≤90 wt. %, the at least one component B in an amount of ≥5 wt. % to ≤50 wt. % and the at least one component C in an amount in the range of ≥0.1 wt. % to ≤20 wt. %, based on the total weight of the collector composition; more preferably the collector composition comprises the at least one component A in an amount in the range of ≥50 wt. % to ≤80 wt. %, the at least one component B in an amount of ≥5 wt. % to ≤40 wt. % and the at least one component C in an amount in the range of ≥1 wt. % to ≤20 wt. %, based on the total weight of the collector composition; even more preferably the collector composition comprises the at least one component A in an amount in the range of ≥60 wt. % to ≤80 wt. %, the at least one component B in an amount of ≥10 wt. % to ≤40 wt. % and the at least one component C in an amount in the range of ≥5 wt. % to ≤20 wt. %, based on the total weight of the collector composition; most preferably the collector composition comprises the at least one component A in an amount in the range of ≥60 wt. % to ≤75 wt. %, the at least one component B in an amount of ≥10 wt. % to ≤35 wt. % and the at least one component C in an amount in the range of ≥8 wt. % to ≤20 wt. %, based on the total weight of the collector composition; and in particular preferably the collector composition comprises the at least one component A in an amount in the range of ≥65 wt. % to ≤75 wt. %, the at least one component B in an amount of ≥15 wt. % to ≤35 wt. % and the at least one component C in an amount in the range of ≥10 wt. % to ≤20 wt. %, based on the total weight of the collector composition.

In another preferred embodiment, the collector composition comprises the at least one component A in an amount in the range of ≥50 wt. % to ≤75 wt. %, the at least one component B in an amount of ≥10 wt. % to ≤35 wt. % and the at least one component C in an amount in the range of ≥10 wt. % to ≤20 wt. %, based on the total weight of the collector composition.

In another preferred embodiment, the collector composition comprises tall oil (67% w/w) and mono and/or di ester of C₁₆-C₁₈(EO)₂Phosphate (33% w/w).

In another preferred embodiment, the collector composition comprises tall oil (67% w/w), C₁₃-C₁₅(EO)₆(PO)₃ phosphate (mono 19.8% w/w) and C₁₂-C₁₄(EO)₂sulphate, (13.2% w/w).

In another preferred embodiment, the collector composition comprises tall oil (67% w/w), C₁₆-C₁₈(EO)₂phosphate (mono/di 16.5% w/w) and mono ester of C₁₃-C₁₅(EO)₆(PO)₃Phosphate, (16.5% w/w).

In another preferred embodiment, the collector composition comprises tall oil (67% w/w) and mono and/or di ester of C₁₆-C₁₈(EO)₂Phosphate (33% w/w).

In another preferred embodiment, the collector composition comprises tall oil (68% w/w) and mono and/or di ester of C₁₆-C₁₈(EO)₂-3Phosphate (32% w/w).

In another preferred embodiment, the collector composition comprises tall oil (68% w/w), C₁₆-C₁₈(EO)₂Phosphate (mono/di 24% w/w), and di(isononyl)adipate (8% w/w).

In another preferred embodiment, the collector composition comprises tall oil (68% w/w), C₁₆-C₁₈(EO)₁₋₁₀ phosphate (mono/di 16% w/w) and mono ester of C₁₃-C₁₅(EO)₆(PO)₃Phosphate, (16% w/w).

In another preferred embodiment, the collector composition comprises tall oil (68% w/w) and mono ester of C₁₃-C₁₅(EO)₆(PO)₃Phosphate (32% w/w).

In another preferred embodiment, the collector composition comprises tall oil (68% w/w), mono ester of C₁₃-C₁₅(EO)₆(PO)₃Phosphate (19.2% w/w) and C₁₂-C₁₄(EO)₂Sulfate monoester, Na salt (12.8% w/w).

### EMBODIMENTS

In the following, there is provided a list of embodiments to further illustrate the present disclosure without intending to limit the disclosure to the specific embodiments listed below.

1. Use of a collector composition for the beneficiation of phosphates from phosphate-containing minerals, wherein the collector composition comprises:
i. at least one component A, and
ii. at least one component B,
   wherein the at least one component A comprises saturated or unsaturated C₈-C₂₂ fatty acids or derivatives thereof containing at least one C(═O)—OH group or salts thereof, and the at least one component B is a compound of formula (I),

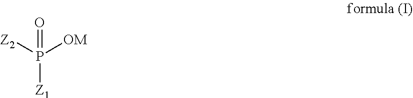

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl.
   2. The use according to embodiment 1, wherein the at least one component A comprises saturated or unsaturated C₁₂-C₁₈ fatty acids or derivatives thereof containing at least one C(═O)—OH group or a salt thereof.
   3. The use according to embodiment 1, wherein the at least one component A comprises saturated or unsaturated C₁₆-C₁₈ fatty acids or derivatives thereof containing at least one C(═O)—OH group or a salt thereof.
   4. The use according to embodiment 1, wherein the at least one component B is a compound of formula (I),

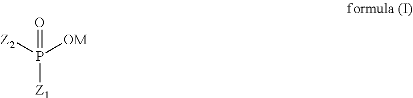

wherein
Z₁ is C₈-C₂₂-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₈-C₂₂-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10, and
R³ and R⁴ are independently of each other selected from H and methyl.
   5. The use according to any of embodiments 1 to 5, wherein the at least one component A is selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, isostearic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.
   6. The use according to any of embodiments 1 to 6, wherein the phosphate-containing minerals are selected from the group consisting of phosphorites, apatites, frondelite and stewarite.
   7. The use according to any of embodiments 1 to 7, wherein the collector composition comprises at least one component C of formula (II) or formula (III) or formula (IV), which is in each case different from the at least one A and the at least one component B,

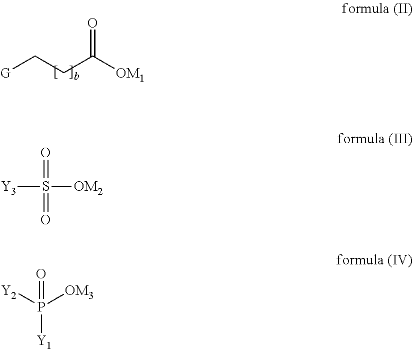

wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.
   8. The use according to any of embodiments 1 to 8, wherein the compound of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, and diisononyladipate.
   9. The use according to embodiment 8, wherein, in the formula (III),
M₂ is an alkali metal ion,
Y₃ is C₁₀-C₂₀-alkyl-O—(CH₂—CH₂—O)ₙ—(—CH(R³)—CH(R⁴)—O—)ₗ(—CH₂—CH₂—O—)ₘ—,
n is an integer in the range from ≥1 to ≤6,
l is an integer in the range from ≥0 to ≤10,
m is an integer in the range from ≥0 to ≤10,
the sum of l+m+n is an integer in the range from ≥1 to ≤10, and
R³ and R⁴ are independently of each other selected from H and methyl.
   10. The use according to embodiment 8, wherein, in the formula (IV),
Y₁ is selected from OM₆, C₈-C₂₂-alkyl-O—(CH₂—CH₂—O)ₙ—(—CH(R³)—CH(R⁴)—O—)ₗ—(—CH₂—CH₂—O—)ₘ—;
Y₂ is C₈-C₂₂-alkyl-O—(CH₂—CH₂—O)ₙ—(—CH(R³)—CH(R⁴)—O—)ₗ(—CH₂—CH₂—O—)ₘ—;
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10,
M₃ and M₆ each are independently selected from the group consisting of alkali metal ions, ammonium, H, C₁-C₂₄ alkyl and C₂-C₂₄; and
R³ and R⁴ are independently of each other selected from H and methyl.
   11. The use according to any of embodiments 1 to 10, wherein the amount of the at least one component A is in the range from ≥50 wt. % to ≤99.9 wt. %, based on the total weight of the collector composition.
   12. The use according to any of embodiments 1 to 10, wherein the amount of the at least one component B is in the range from ≥0.1 wt. % to ≤50 wt. %, based on the total weight of the collector composition.
   13. The use according to embodiment 12, wherein the amount of the at least one component B is in the range from ≥10 wt. % to ≤30 wt. %, based on the total weight of the collector composition.
   14. The use according to any of embodiments 1 to 13, wherein the amount of the at least one component C is in the range from ≥0.1 wt. % to ≤20 wt. %, based on the total weight of the collector composition.
   15. The use according to any of embodiments 1 to 10, wherein the collector composition comprises the at least one component A in an amount in the range of ≥50 wt. % to ≤90 wt. % and the at least one component B in an amount of ≥5 wt. % to ≤35 wt. %, based on the total weight of the collector composition.
   16. The use according to any of embodiments 1 to 10, wherein the collector composition comprises the at least one component A in an amount in the range of ≥50 wt. % to ≤75 wt. % and the at least one component B in an amount of ≥10 wt. % to ≤25 wt. %, based on the total weight of the collector composition.
   17. The use according to any of embodiments 1 to 10, wherein the collector composition comprises the at least one component A in an amount in the range of ≥50 wt. % to ≤90 wt. %, the at least one component B in an amount of ≥5 wt. % to ≤35 wt. % and the at least one component C in an amount in the range of ≥0.1 wt. % to ≤20 wt. %, based on the total weight of the collector composition.
   18. The use according to any of embodiments 1 to 10, wherein the collector composition comprises the at least one component A in an amount in the range of ≥50 wt. % to ≤75 wt. %, the at least one component B in an amount of ≥10 wt. % to ≤25 wt. % and the at least one component C in an amount in the range of ≥5 wt. % to ≤15 wt. %, based on the total weight of the collector composition.
   19. A direct flotation process for the beneficiation of phosphates from phosphate-containing o minerals comprising the steps of:
   a) grinding phosphate-containing mineral particles in water to obtain an aqueous mixture,
   b) adjusting the pH of the aqueous mixture obtained in step a) to a desired level to obtain a pH adjusted aqueous mixture,
   c) optionally, adding a depressant to the aqueous mixture,
   d) adding the collector composition to the pH adjusted aqueous mixture,
   e) agitating the pH adjusted aqueous mixture obtained in step d) under air injection to generate froth, and
   f) collecting of the phosphate in the froth;
      wherein the collector composition is as defined as embodiments 1 to 18.
      20. The direct flotation process according to embodiment 19, wherein the collector composition comprises at least one component C of formula (II) or formula (III) or formula (IV), which is in each case different from the at least one component A and the component at least one component B,

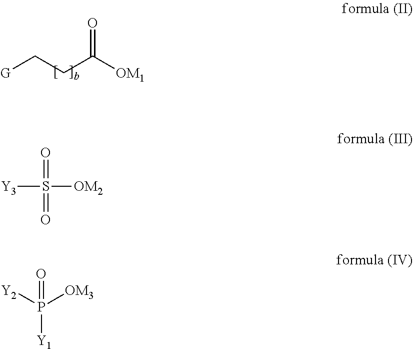

wherein G, b, Y₁, Y₂, Y₃, M₁, M₂ and M₃ are as defined as in embodiment 7.
21. The direct flotation process according to embodiment 19, wherein the process comprises the step of adding one or more modifiers and/or one or more frothers and/or one or more depressants before step d).
22. The direct flotation process according to embodiment 19 to 21, wherein the phosphate-containing minerals are pretreated to remove silicates.
23. The direct flotation process according to any of embodiments 19 to 22, wherein the phosphate-containing mineral particles have a size in the range of 0.001 to 1 mm determined according to sieve tower method or granulometry method.
24. The direct flotation process according to any of embodiments 19 to 23, wherein the amount of the collector composition is in the range of 10 g to 10 Kg per 1000 kg phosphate mineral.
25. A reverse flotation process for the beneficiation of the phosphate-containing minerals by collection of impurities from phosphate-containing mineral in the froth, comprising the steps of:
a) grinding the phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting carbonate and/or other impurities in the froth, and
g) recovering the phosphates;
   wherein the collector composition is as defined as embodiments 1 to 18.
   26. The reverse flotation process according to embodiment 25, wherein the collector composition comprises at least one component C of formula (II) or formula (III) or formula (IV), which is in each case different from the at least one component A and the at least one component B,

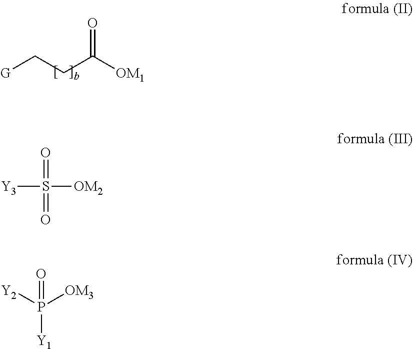

wherein G, b, Y₁, Y₂, Y₃, M₁, M₂ and M₃ are as defined as in embodiment 7.
27. The reverse flotation process according to embodiment 26, wherein the process comprises the step of adding one or more modifiers and/or one or more frothers and/or one or more depressants before step d).
28. The reverse flotation process according to embodiment 26, wherein the phosphate-containing minerals are pretreated to remove silicates.
29. The reverse flotation process according to any of embodiments 26 to 28, wherein the phosphate-containing mineral particles have a size in the range of 0.001 to 1 mm determined according to sieve tower method or granulometry method.
30. The reverse flotation process according to any of embodiments 26 to 29, wherein the amount of the collector composition is in the range of 10 g to 10 Kg per 1000 kg phosphate mineral.
31. A collector composition for the beneficiation of phosphates from phosphate-containing minerals comprising
i. at least one component A,
ii. at least one component B, and
iii. at least one component C,
   wherein the at least one component A comprises saturated or unsaturated C₈-C₂₂ fatty acids or derivatives thereof containing at least one C(═O)—OH group or salts thereof, and the at least one component B is a compound of formula I

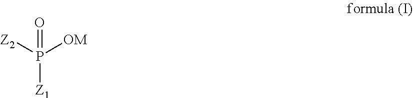

wherein
Z₁ is C₆-C₃₀-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl; and the at least one component C is selected from the group consisting of formula (II), formula
   (III) and formula (IV), which is in each case different from at least one component A and the at least one component B,

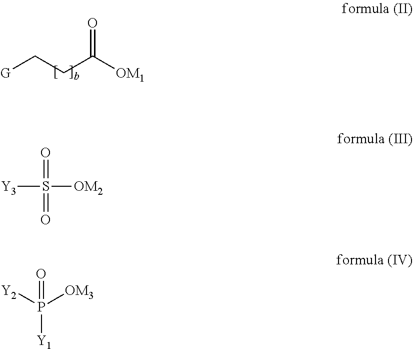

wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.
   32. The collector composition according to embodiment 31, wherein the at least one component A comprises saturated or unsaturated C₁₂-C₁₈ fatty acids or derivatives thereof containing at least one C(═O)—OH group or a salt thereof.
   33. The collector composition according to embodiment 31, wherein the at least one component A comprises saturated or unsaturated C₁₆-C₁₈ fatty acids or derivatives thereof containing at least one C(═O)—OH group or a salt thereof.
   34. The collector composition according to embodiment 31, wherein the at least one component B is a compound of formula (I),

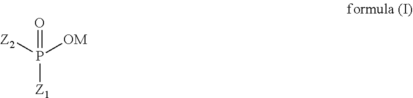

wherein
Z₁ is C₈-C₂₂-alkyl-O—(CH₂—CH₂—O)ₙ—(—CH(R³)—CH(R⁴)—O—)ₗ(—CH₂—CH₂—O—)ₘ—;
Z₂ is selected from OM₅ and C₈-C₂₂-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10, and
R³ and R⁴ are independently of each other selected from H and methyl.
   35. The collector composition according to any of embodiments 31 to 34, wherein the at least one component A is selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, isostearic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid and mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, and/or fatty acids derived from other plant or animal-based triglycerides, and/or fractions of such blends.
   36. The collector composition according to any of embodiments 31 to 35, wherein the phosphate-containing minerals are selected from the group consisting of phosphorites, apatites, hydroxyoapatite, fluoroapatite, chloroapatite, carbonatoapatite and bromoapatite, frondelite and stewarite.
   37. The collector composition according to any of embodiments 31 to 36, wherein the compound of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, and diisononyladipate.
   38. The collector composition according to embodiment 31, wherein, in the formula (III),
M₂ is an alkali metal ion,
Y₃ is C₁₀-C₂₀-alkyl-O—(CH₂—CH₂—O)ₙ—(—CH(R³)—CH(R⁴)—O—)ₗ—(—CH₂—CH₂—O—)ₘ—,
n is an integer in the range from ≥1 to ≤6,
l is an integer in the range from ≥0 to ≤10,
m is an integer in the range from ≥0 to ≤10,
the sum of l+m+n is an integer in the range from ≥1 to ≤10, and
R³ and R⁴ are independently of each other selected from H and methyl.
   39. The collector composition according to embodiment 31, wherein, in the formula (IV),
Y₁ is C₈-C₂₂-alkyl-O—(CH₂—CH₂—O)ₙ—(—CH(R³)—CH(R⁴)—O—)ₗ(—CH₂—CH₂—O—)ₘ—;
Y₂ is selected from OM₆ and C₈-C₂₂-alkyl-O—(CH₂—CH₂—O)ₙ—(—CH(R³)—CH(R⁴)—O—)ₗ—(—CH₂—CH₂—O—)ₘ—;
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10,
M₃ and M₆ each are independently selected from the group consisting of alkali metal ions, H, C₁-C₂₄ alkyl and C₂-C₂₄ alkenyl with a branching degree between 0 and 4; and
R³ and R⁴ are independently of each other selected from H and methyl.
   40. The collector composition according to any of embodiments 31 to 39, wherein the amount of the at least one component A is in the range from ≥50 wt. % to ≤99.9 wt. %, based on the total weight of the collector composition.
   41. The collector composition according to any of embodiments 31 to 39, wherein the amount of the at least one component B is in the range from ≥0.1 wt. % to ≤50 wt. %, based on the total weight of the collector composition.
   42. The collector composition according to embodiment 41, wherein the amount of the at least one component B is in the range from ≥10 wt. % to ≤30 wt. %, based on the total weight of the collector composition.
   43. The collector composition according to any of embodiments 31 to 42, wherein the amount of the at least one component C is in the range from ≥0.1 wt. % to ≤20 wt. %, based on the total weight of the collector composition.
   44. The collector composition according to any of embodiments 31 to 39, wherein the collector composition comprises the at least one component A in an amount in the range of ≥50 wt. % to ≤90 wt. %, the at least one component B in an amount of ≥5 wt. % to ≤35 wt. % and the at least one component C in an amount in the range of ≥0.1 wt. % to ≤20 wt. %, based on the total weight of the collector composition.
   45. The collector composition according to any of embodiments 31 to 39, wherein the collector composition comprises the at least one component A in an amount in the range of ≥50 wt. % to ≤75 wt. %, the at least one component B in an amount of ≥10 wt. % to ≤25 wt. % and the at least one component C in an amount in the range of ≥5 wt. % to ≤15 wt. %, based on the total weight of the collector composition.

While the presently claimed invention has been described in terms of its specific embodiments, certain modifications and equivalents will be apparent to those skilled in the art and are intended to be included within the scope of the presently claimed invention

### EXAMPLES

The presently claimed invention is illustrated in detail by non-restrictive working examples which follow. More particularly, the test methods specified hereinafter are part of the general disclosure of the application and are not restricted to the specific working examples.

### Materials

Tall oil is available from BASF.

C₁₆-C₁₈(EO)₃Phosphate (mono/di)sodium salt is available from BASF.

C₁₆-C₁₈(EO)₂Phosphate (mono/di) sodium salt is available from BASF.

C₁₃-C₁₅(EO)₆(PO)₃Phosphate, mono sodium salt is available from BASF.

C₁₃-C₁₅(EO)₆(PO)₃Phosphate, mono sodium salt is available from BASF.

C₁₂-C₁₄(EO)₂Sulfate, monoester, sodium salt is available from BASF.

C₁₃-C₁₅(EO)₆(PO)₃Phosphate, mono, sodium salt is available from BASF.

C₁₆-C₁₈(EO)₁₀Phosphate mono/di sodium salt is available from BASF.

Mineral from northern Europe with a composition given in table 1 was used for the trials.

TABLE 1

| Com- | Apatite mineral composition. | | | | | | | | |
|---|---|---|---|---|---|---|---|---|---|
| ponent | P₂O₅ | Al₂O₃ | SiO₂ | CaO | Fe | K₂O | Na₂O | MgO | TiO₂ |
| Content, | 14.30 | 14.40 | 31.07 | 15.32 | 8.17 | 3.44 | 5.63 | 1.79 | 2.31 |
| % | | | | | | | | | |

Flotation water was prepared by the addition of separate components to deionized water to obtain a water composition which is given in table 2.

TABLE 2
Water composition.

| | Ions content, mg/l | | | | | | | | |
|---|---|---|---|---|---|---|---|---|---|
| pH | Ca2⁺ | Mg2⁺ | SO₄²⁻ | CO₃²⁻ | Cl⁻ | Na⁺ | NO₂ | NO₃ | NH₄ |
| 10.0 | 8.9 | 0.87 | 413.03 | 532.02 | 15.75 | 513.08 | 3.65 | 52.28 | 3.58 |

The mineral portion for each test was grinded in a laboratory ball mill. The grain size characteristic is given in table 3.

TABLE 3
Grinded mineral granulometric characteristics.

| | | | | |
|---|---|---|---|---|
| Grain size, mm | +0.45 | −0.45 | −0.16 | −0.071 |
| | | +0.16 | +0.071 | |
| Content, % | 0.74 | 1.55 | 84.96 | 12.75 |

The component A used for the collector mixtures was tall oils. The caustic soda solution was used for tall oils saponification and the hydrolyzed tall oil product was directly used as component A. Component B and component C were mixed with the hydrolyzed tall oil product to obtain the collector composition. Liquid glass (400 g/t) was added to the slurry prior to the flotation. Optionally modifiers, frothers and depressants were added to the composition. The results are summarized in the below table 4.

### General Procedure:

A crushed igneous phosphate mineral feed, containing 14% P2O5 has been used for the experiments. Sample preparation included wet grinding in a laboratory ball mill with stainless steel balls. The flotation experiments were performed in flotation in an open cycle with two concentrate cleaning stages (Mekhanobr design werte). The sample mineral was conditioned with 95 g/t collector bend and the results are tabulated in table 4.

General procedure for synthesis of compounds of formula (III): Alkyl ether sulfates are generated by a reaction of an alcohol (alkoxylate) with a gaseous sulfur (VI) oxide and subsequent neutralization with an excess amount of base.

General procedure for synthesis of compounds of formula (IV): The phosphate esters are typically produced by a reaction of corresponding alkyl alkoxylates with polyphosphoric acid (for monoesters) or with P₂O₅ for a blend of mono- and diesters.

### Table 4

In each example 67 w/w % component A was used along with component B and/or component C related to overall weight of the composition. Weight % of component B and/or component C in the composition is given in below table. Each experiments the collector mixture dosage in open-cycle tests was 95 g/t.

| | | | | Conc. | |
|---|---|---|---|---|---|
| | | | Flotation | grade. % | Conc. |
| Ex. | Component B (w/w %) | Component C (w/w %) | cycle | P₂O₅ | recovery, % |
| 1 | C₁₆-C₁₈(EO)₃Phosphate | None | Open | 39.87 | 79.96 |
| | (mono/di) (33%) | | | | |
| 2 | C₁₃-C₁₅(EO)₆(PO)₃Phosphate, | C₁₂-C₁₄(EO)₂Sulfate, | | 39.41 | 82.46 |
| | mono, (19.8%) | monoester, Na salt | | | |
| | | (13.2%) | | | |
| 3 | C₁₆-C₁₈(EO)₁₀Phosphate | C₁₃-C₁₅(EO)₆(PO)₃Phosphate, | | 40.28 | 83.76 |
| | mono/di (16.5%) | mono (16.5%) | | | |
| 4 | C₁₆-C₁₈(EO)₁₀Phosphate | None | | 40.25 | 87.96 |
| | (mono/di) (33%) | | | | |

EO—ethyleneoxy, PO—propyleneoxy

It is evident from the table that the compositions of the presently claimed invention provides a solution for obtaining phosphates concentrate with a high grade at very high recovery in the froth floatation technique with less quantity of the collector composition.

The compositions of the presently claimed invention provided for a greater recovery of phosphates at a smaller dose of the collector composition. Also, it was found that the collector compositions according to presently claimed invention were suitable for the separation of carbonates contained in phosphoric rock by flotation. The collector composition of presently claimed invention prevented the formation of excessive foam.

The presently claimed invention is associated with at least one of the following advantages:

(i) A high-grade phosphate concentrate is obtained in a high yield by using the collector composition according to the presently claimed invention in comparatively low amounts.
(ii) A high-grade phosphate concentrate is obtained in a high yield from a low grade phosphate mineral by using the collector composition according to the presently claimed invention.
(iii) The collector composition according to presently claimed invention is suitable for the separation of carbonates contained in phosphoric rock by flotation.
(iv) The collector composition of the presently claimed invention also prevents the formation of excessive foam during the flotation.

1. A method of using a collector composition, comprising:
performing beneficiation of phosphates from phosphate-containing mineral using the collector composition, wherein the collector composition comprises:
i. at least one component A, and
ii. at least one component B,
wherein the at least one component A comprises saturated or unsaturated C₈-C₂₂ fatty acids or derivatives thereof containing at least one C(═O)—OH group or salts thereof, and
the at least one component B is a compound of formula (I), 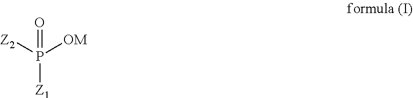
wherein
Z₁ is C₆-C₃₀-alkyl-O—(CH₂—CH₂—O)ₙ—(—CH(R³)—CH(R⁴)—O—)ₗ—(—CH₂—CH₂—O—)ₘ—;
Z₂ is selected from the group consisting of OM₅ and C₆-C₃₀-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl.

2. The method according to claim 1, wherein the at least one component A comprises saturated or unsaturated C₁₂-C₁₈ fatty acids or derivatives thereof containing at least one C(═O)—OH group or a salt thereof.

3. The method according to claim 1, wherein the at least one component B is a compound of formula (I), 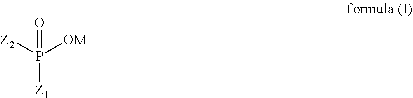
wherein
Z₁ is C₈-C₂₂-alkyl-O—(CH₂—CH₂—O)ₙ—(—CH(R³)—CH(R⁴)—O—)ₗ—(—CH₂—CH₂—O—)ₘ—;
Z₂ is selected from the group consisting of OM₅ and C₈-C₂₂-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10, and
R³ and R⁴ are independently of each other selected from H and methyl.

4. The method according to claim 1, wherein the at least one component A is selected from the group consisting of octanoic acid, nonanoic acid, decanoic acid, undecanoic acid, dodecanoic acid, tridecanoic acid, tetradecanoic acid, pentadecanoic acid, hexadecanoic acid, heptadecanoic acid, isostearic acid, octadecanoic acid, nonadecanoic acid, eicosanoic acid, heneicosanoic acid, docosanoic acid, α-linolenic acid, stearidonic acid, eicosapentaenoic acid, docosahexaenoic acid, linoleic acid, linolelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, mead acid, and derivatives thereof containing at least one carboxylic group, tall oil or its fractions, fatty acids generated by the hydrolysis of tallow, fish oil, soybean oil, rapeseed oil, sunflower oil, corn oil, safflower oil, palm oil, palm kernel oil, or fatty acids derived from other plant or animal-based triglycerides or fractions of such blends or combinations thereof.

5. The method according to claim 1, wherein the phosphate-containing mineral is selected from the group consisting of phosphorites, apatites, frondelite and stewarite.

6. The method according to claim 1, wherein the collector composition comprises at least one component C of formula (II) or formula (III) or formula (IV), which is in each case different from the at least one component A and the at least one component B, 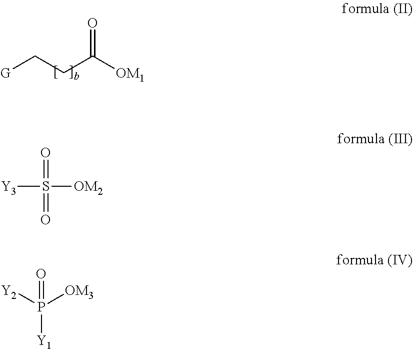
wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ is selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20,
R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of H, C₁-C₂₄ alkyl and C₂-C₂₄ alkenyl.

7. The method according to claim 1, wherein the compound of formula (II) is selected from the group consisting of di-(n-octyl) adipate, di-(n-nonyl)adipate, di-(n-decyl) adipate, di-(2-propylheptyl)-adipate, di-(2-ethylhexyl)adipate, diisooctyl adipate, diisodecyl adipate, diisotridecyl adipate, diisoundecyl adipate, diisododecyl adipate, and diisononyladipate.

8. The method according to claim 6, wherein, in the formula (III):
M₂ is an alkali metal ion,
Y₃ is C₁₀-C₂₀-alkyl-O—(CH₂—CH₂—O)ₙ—(—CH(R³)—CH(R⁴)—O—)ₗ—(—CH₂—CH₂—O—)ₘ—,
n is an integer in the range from ≥1 to ≤6,
l is an integer in the range from ≥0 to ≤10,
m is an integer in the range from ≥0 to ≤10,
the sum of l+m+n is an integer in the range from ≥1 to ≤10, and
R³ and R⁴ are independently of each other selected from H and methyl.

9. The method according to claim 6, wherein, in the formula (IV),
Y₁ is C₈-C₂₂-alkyl-O—(CH₂—CH₂—O)ₙ—(—CH(R³)—CH(R⁴)—O—)ₗ—(—CH₂—CH₂—O—)ₘ—;
Y₂ is selected from the group consisting of OM₆ and C₈-C₂₂-alkyl-O—(CH₂—CH₂—O)ₙ—(—CH(R³)—CH(R⁴)—O—)ₗ—(—CH₂—CH₂—O—)ₘ—;
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10,
M₃ and M₆ each are independently selected from the group consisting of alkali metal ions, ammonium, H, C₁-C₂₄ alkyl and C₂-C₂₄ alkenyl; and
R³ and R⁴ are independently of each other selected from H and methyl.

10. The method according to claim 1, wherein:
i) the amount of the at least one component A is in the range from ≥50 wt. % to ≤99.9 wt. %, based on the total weight of the collector composition,
ii) the amount of the at least one component B is in the range from ≥0.1 wt. % to ≤50 wt. %, based on the total weight of the collector composition,
iii) the collector composition further comprises at least one component C and the amount of the at least one component C is in the range from ≥0.1 wt. % to ≤20 wt. %, based on the total weight of the collector composition, wherein the component C is different from the at least one component A and the at least one component B, or
any combination of two or more of i), ii) or iii), or
iv) the amount of the at least one component A is in the range of ≥50 wt. % to ≤75 wt. % and the amount of at least one component B is in the range of ≥10 wt. % to ≤25 wt. %, based on the total weight of the collector composition, or
v) the amount of the at least one component A is in the range of ≥50 wt. % to ≤90 wt. %, the amount of the at least one component B is in the range of ≥5 wt. % to ≤35 wt. % and the amount of the at least one component C is in the range of ≥0.1 wt. % to ≤20 wt. %, based on the total weight of the collector composition.

11-14. (canceled)

15. A direct flotation process for the beneficiation of phosphates from phosphate-containing mineral comprising the steps of:
a) grinding phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting of the phosphate in the froth;
wherein the collector composition is as defined in claim 1.

16. The direct flotation process according to claim 15, wherein the collector composition comprises at least one component C of formula (II) or formula (III) or formula (IV), which is in each case different from the at least one component A and the at least one component B, 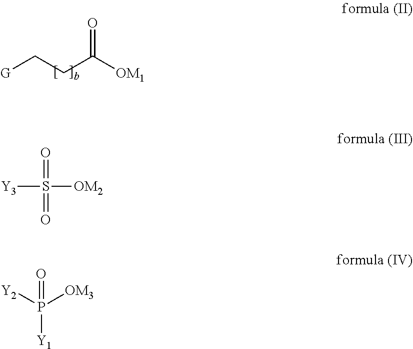
wherein G, b, Y₁, Y₂, Y₃, M₁, M₂ and M₃ are as defined as in claim 6.

17. The direct flotation process according to claim 15, wherein the process comprises adding i) one or more modifiers, ii) one or more frothers, iii) one or more depressants or any combination of i), ii) and iii) before step d).

18. The direct flotation process according to claim 15, wherein the amount of the collector composition is in the range of 10 g to 10 Kg per 1000 kg phosphate mineral.

19. A reverse flotation process for the beneficiation of the phosphate-containing mineral by collection of impurities from phosphate-containing mineral in the froth, comprising the steps of:
a) grinding the phosphate-containing mineral particles in water to obtain an aqueous mixture,
b) adjusting the pH of the aqueous mixture obtained in step a) to a desired level to obtain a pH adjusted aqueous mixture,
c) optionally, adding a depressant to the aqueous mixture,
d) adding the collector composition to the pH adjusted aqueous mixture,
e) agitating the pH adjusted aqueous mixture obtained in step d) under air injection to generate froth, and
f) collecting carbonate and/or other impurities in the froth, and
g) recovering the phosphates;
wherein the collector composition is as defined in claim 1.

20. The reverse flotation process according to claim 19, wherein the collector composition comprises at least one component C of formula (II) or formula (III) or formula (IV), which is in each case different from the at least one component A and the at least one component B, 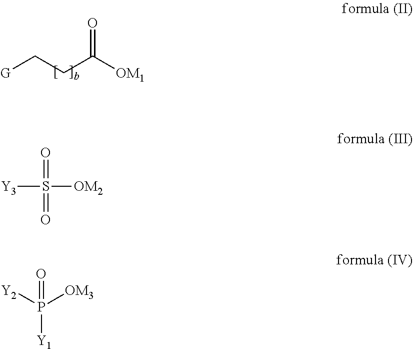
wherein G, b, Y₁, Y₂, Y₃, M₁, M₂ and M₃ are as defined as in claim 6.

21. The reverse flotation process according to claim 19, wherein the amount of the collector composition is in the range of 10 g to 10 Kg per 1000 kg phosphate mineral.

22. A collector composition for the beneficiation of phosphates from phosphate-containing mineral comprising:
i. at least one component A,
ii. at least one component B, and
iii. at least one component C,
wherein the at least one component A comprises saturated or unsaturated C₈-C₂₂ fatty acids or derivatives thereof containing at least one C(═O)—OH group or salts thereof, and the at least one component B is a compound of formula (I), 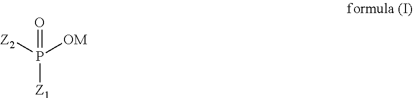
wherein
Z₁ is C₆-C₃₀-alkyl-O—(CH₂—CH₂—O)ₙ—(—CH(R³)—CH(R⁴)—O—)ₗ—(—CH₂—CH₂—O—)ₘ—;
Z₂ is selected from the group consisting of OM₅ and C₆-C₃₀-alkyl-O—(CH₂—CH₂—O)ₙ—(—CH(R³)CH(R⁴)—O—)ₗ—(—CH₂—CH₂—O—)ₘ—;
M and M₅ are H, ammonium or an alkali metal ion,
N is an integer in the range from ≥0 to ≤10,
l is an integer in the range from ≥0 to ≤10,
m is an integer in the range from ≥0 to ≤10,
the sum of l+m+n is an integer in the range from ≥1 to ≤20; and
R³ and R⁴ are independently of each other selected from H and C₁-C₆-alkyl; and
the at least one component C is selected from the group consisting of of formula (II), formula (III) and formula (IV), which is in each case different from the at least one component A and the at least one component B, 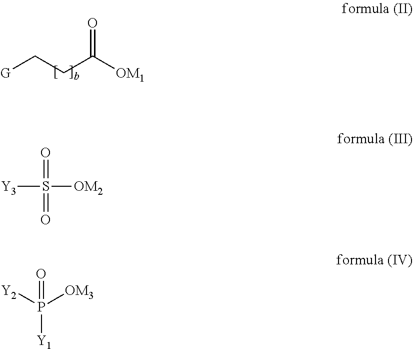
wherein
G is H or C(═O)—OM₄;
b is an integer in the range from ≥2 to ≤20;
Y₁ is selected from the group consisting of OM₆, C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
Y₂ and Y₃ are independently selected from the group consisting of C₁-C₂₄ alkyl, C₂-C₂₄ alkenyl, OR and C₆-C₃₀-alkyl-O—(CH₂—CH₂—O)ₙ—(—CH(R³)—CH(R⁴)—O—)ₗ—(—CH₂—CH₂—O—)ₘ—,
n is an integer in the range from ≥0 to ≤10,
l is an integer in the range from ≥0 to ≤10,
m is an integer in the range from ≥0 to ≤10,
the sum of l+m+n is an integer in the range from ≥1 to ≤20, R³ and R⁴ are independently of each other selected from H and C₁-C₆-alkyl;
M₁ is selected from the group consisting of C₁-C₂₄ alkyl and C₂-C₂₄ alkenyl;
M₂, M₃, M₄ and M₆ each are independently selected from the group consisting of alkali metal ions, ammonium, H, C₁-C₂₄ alkyl and C₂-C₂₄ alkenyl; and
R is selected from the group consisting of C₁-C₂₄ alkyl and C₂-C₂₄ alkenyl.

23. The collector composition according to claim 22, wherein the at least one component A comprises saturated or unsaturated C₁₂-C₁₈ fatty acids or derivatives thereof containing at least one C(═O)—OH group or a salt thereof.

24. The collector composition according to claim 22, wherein the at least one component B is a compound of formula (I), 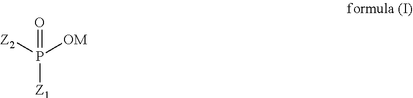
wherein
Z₁ is C₈-C₂₂-alkyl-O—(CH₂—CH₂—O)ₙ—(—CH(R³)—CH(R⁴)—O—)ₗ—(—CH₂—CH₂—O—)ₘ—;
Z₂ is selected from the group consisting of OM₅ and C₈-C₂₂-alkyl-O—(CH₂—CH₂—O)ₙ—(—CH(R³)—CH(R⁴)—O—)ₗ—(—CH₂—CH₂—O—)ₘ—;
M and M₅ are H, ammonium or an alkali metal ion,
n is an integer in the range from ≥1 to ≤7,
l is an integer in the range from ≥0 to ≤4,
m is an integer in the range from ≥0 to ≤3,
the sum of l+m+n is an integer in the range from ≥1 to ≤10, and
R³ and R⁴ are independently of each other selected from H and methyl.

25. (canceled)
